(19) United States
(12) Patent Application Publication
(10) Pub. No.: US 2025/0227091 A1
(43) Pub. Date: Jul. 10, 2025

(54) DYNAMIC FILE TRANSFER AND GENERATION SYSTEM

(71) Applicant: Onivas Technologies, Inc., Bradenton, FL (US)

(72) Inventors: Keith Savino, Bradenton, FL (US); Richard A. Savino, Lakewood Ranch, FL (US); Michael Thomas Herron, Burlington, IA (US); Marc R. Still, Dallas, TX (US); Elizabeth Pipkin, Crockett, CA (US); Gail Jordan, Dallas, TX (US); Katherine H. Ambers, N. Chesterfield, VA (US)

(73) Assignee: Onivas Technologies, Inc., Bradenton, FL (US)

(21) Appl. No.: 19/013,757

(22) Filed: Jan. 8, 2025

Related U.S. Application Data
(60) Provisional application No. 63/618,710, filed on Jan. 8, 2024.

(51) Int. Cl. H04L 9/40

(52) U.S. Cl. CPC H04L 63/04

(57) ABSTRACT

There is provided a device and a method for generating and proliferating content. The device includes presenting at least one content, perform at least one function based on selection of at least one of the at least one content, presenting, based on the at least one function being opening the at least one content for editing, a content editing interface including at least one field associated with a first content of the at least one content, and perform a field proliferation operation, which includes copying data entered into a first field of the at least one field into at least one second fields associated with at least one second contents based on an identifier associated with the first field matching an identifier associated with the at least one second fields, and based on a field proliferation option.

### BACKGROUND

### 1. Field

Embodiments of the disclosure relate to a system for efficiently transferring, storing, encrypting, and decrypting data between multiple devices. Embodiments of the disclosure also relate to a graphical user interface enabling efficient generation of files, authorization to transfer particular files, file access request generation, access of transferred files, display of files, modification of files, and version control of files. Embodiments of the disclosure also relate to flagging files that do not conform to particular standards, including regulatory, industry, and standards set or specified by a user, and modifying files to conform to particular standards, including regulatory, industry, and standards set or specified by a user.

### 2. Description of Related Art

In related art systems, a content provision system may generate, transfer, or otherwise modify content containing restricted data. Regulatory compliance may prohibit the use of cellular networks or public internet connections. In related art systems, databases do not store user data for use in future form generation. Related art systems in this field may be incompatible or inefficient to use with mobile interfaces. In related art systems, users may need to repeatedly and manually recreate substantially similar forms. Accordingly, distributers and consumers may need to manually enter similar data repeatedly, and only when online and at a workstation, reducing both access and efficiency of the system for both distributers and consumers.

### SUMMARY

Accordingly, in order to resolve the above described problems and other problems in the field of content provision and generation, embodiments of the disclosure provide a system for efficiently generating, transferring, accessing, displaying, and modifying files in order to provide a more efficient, streamlined user experience, that reduces the need for online access and manual input.

Embodiments of the disclosure provide an integrated mobile and workstation solution, effectively solving the related art problem of incompatibility with mobile interfaces.

Embodiments of the disclosure enable crowd-sourcing of files and forms, effectively solving the related art problem of needing to recreate substantially similar forms.

Embodiments of the disclosure function in offline operation, effectively solving the need for secure online access.

### BRIEF DESCRIPTION OF THE DRAWINGS

FIG. 1 represents a menu interface according to some embodiments of the disclosure.

FIG. 2 represents a client reference interface according to some embodiments of the disclosure.

FIG. 3a represents a form editing interface according to some embodiments of the disclosure.

FIG. 3b represents a form editing interface according to some embodiments of the disclosure.

FIG. 4a is a flowchart representing a form sharing process according to some embodiments of the disclosure.

FIG. 4b represents a form editing interface according to some embodiments of the disclosure.

FIG. 4c represents a form sharing interface according to some embodiments of the disclosure.

FIG. 4d represents a form sharing process according to some embodiments of the disclosure.

FIG. 4e represents a form editing interface according to some embodiments of the disclosure.

FIG. 4f represents a notification according to some embodiments of the disclosure.

FIG. 4g represents a form intake interface according to some embodiments of the disclosure.

FIG. 4h represents a form intake interface according to some embodiments of the disclosure.

FIG. 4i represents a form intake interface according to some embodiments of the disclosure.

FIG. 4j represents a form intake interface according to some embodiments of the disclosure.

FIG. 5 represents a menu interface according to some embodiments of the disclosure.

FIG. 6 represents a menu interface according to some embodiments of the disclosure.

FIG. 7 represents a menu interface according to some embodiments of the disclosure.

FIG. 8a represents a form management interface according to some embodiments of the disclosure.

FIG. 8b represents a form management interface according to some embodiments of the disclosure.

FIGS. 9a-9d represent form designer interfaces according to some embodiments of the disclosure.

FIG. 10a-10c represent distributer management interfaces according to some embodiments of the disclosure.

FIG. 11 represents a landing screen according to some embodiments of the disclosure.

FIG. 12 represents a method according to some embodiments of the disclosure.

FIG. 13 represents an example system according to some embodiments of the disclosure.

FIG. 14 represents a configuration menu according to some embodiments of the disclosure.

FIG. 15 represents a mobile interface according to some embodiments of the disclosure.

FIG. 16 represents a zoomed mobile interface according to some embodiments of the disclosure.

FIG. 17 represents a data integration interface according to some embodiments of the disclosure.

FIG. 18 represents a data integration and exportation interface according to some embodiments of the disclosure.

FIGS. 19a-19c represent example user interfaces for generating reusable links according to one or more embodiments.

FIGS. 20a-20j represent example user interfaces for managing and sharing reusable links according to one or more embodiments.

FIG. 21 represents an example user interface for managing reusable link folders.

FIGS. 22a-22b represent example user interfaces for integrating content received from a reusable link.

FIG. 23 represents an example user interface for integrating content received from a reusable link.

FIG. 24 represents an example user interface for integrating content received from a reusable link.

FIG. 25 represents an example user interface for managing reusable links.

FIGS. 26a-26b represent example user interfaces for managing reusable links.

FIG. 27 represents an example user interface from the perspective of a user filling out data using a reusable link.

### DETAILED DESCRIPTION

As the disclosure provides support for numerous embodiments, particular embodiments will be illustrated in the drawings and described in detail in the written description. However, one of ordinary skill in the art will recognize that the disclosure is not limited to particular modes of practice, and it will be understood that all changes, equivalents, and substitutes that do not depart from the spirit and technical scope of the disclosure are encompassed in the disclosure.

In the description of the embodiments, certain detailed explanations of related art are omitted when such explanations might unnecessarily obscure the essence of the disclosure.

In the disclosure, regarding an element represented as a “unit” or a “module,” two or more elements may be combined into one element or one element may be divided into two or more elements according to subdivided functions. In addition, each element described hereinafter may additionally perform some or all of functions performed by another element, in addition to main functions of itself, and some of the main functions of each element may be performed entirely by another component.

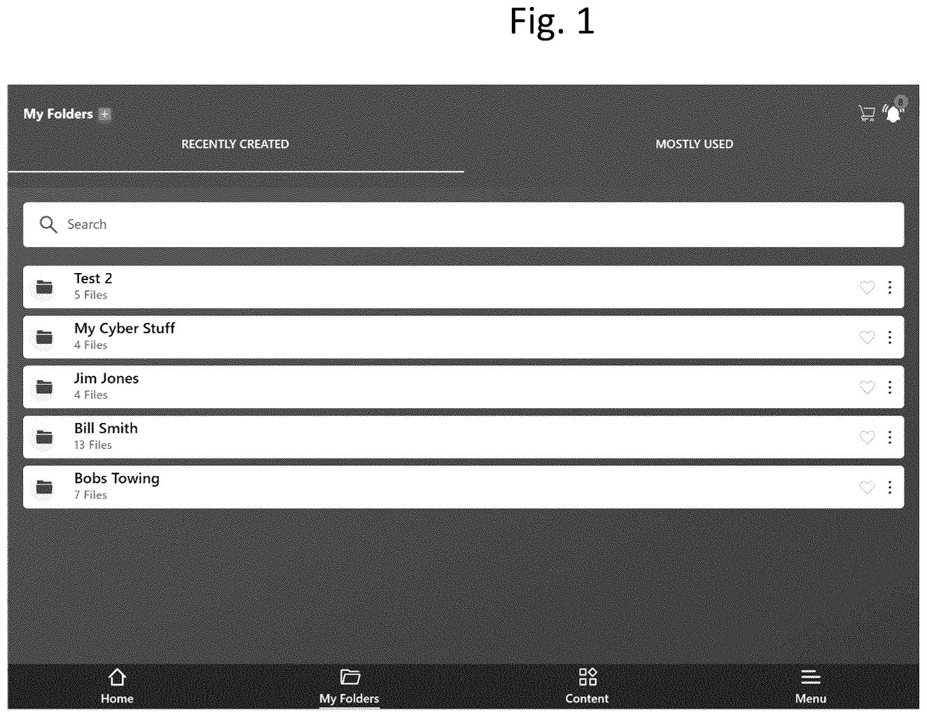

Referring now to FIG. 1, an example interface is provided for accessing files. The interface may be associated with folders. The folders may further be associated with reference information. In some embodiments, the reference information is a business relationship. In some embodiments, selecting a folder enables a user to add forms or other content to the folder. In some embodiments, selecting a folder enables a user to share one or more contained forms or content through one or more content sharing methods, which will be described in detail below. In some embodiments, only folders associated with a certain search term, associated with a particular industry standard or regulation, or associated with a certain business type may be displayed. Such operations may be conditional upon settings configurable by a user.

For example, a displayed folder may indicate that a business is an insurance business, and may indicate a business title, address, client or organizational relationship, or a custom category as defined by a user. A displayed folder may indicate that contents of the folder are associated with a certain standard or regulation. For example, the folder may indicate that the contents of the folder relate to, or meet an ACORD standard.

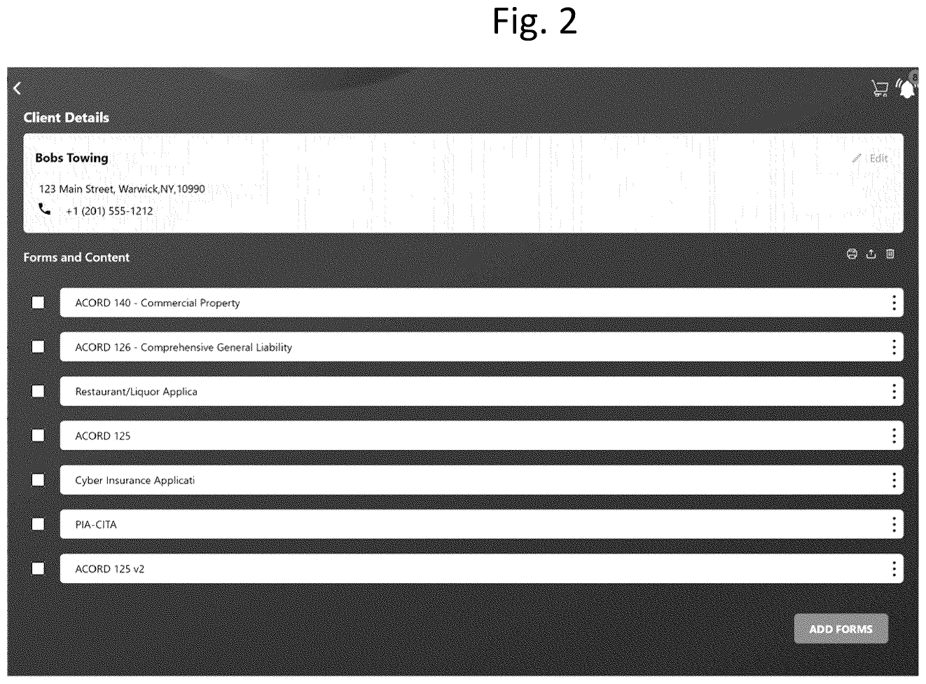

Referring now to FIG. 2, an example interface for interacting with folders is provided. The interface may provide reference information associated with the folder. The reference information may be a business relationship. In some embodiments, the interface allows a user to select one or more functions to perform. In some embodiments, the functions may be adding an additional folder, adding one or more new forms, importing one or more existing forms, opening one or more forms for editing, sharing one or more forms, printing one or more forms, editing the reference information associated with the folder, renaming one or more applications associated with the folder, or copying one or more applications associated with the folder.

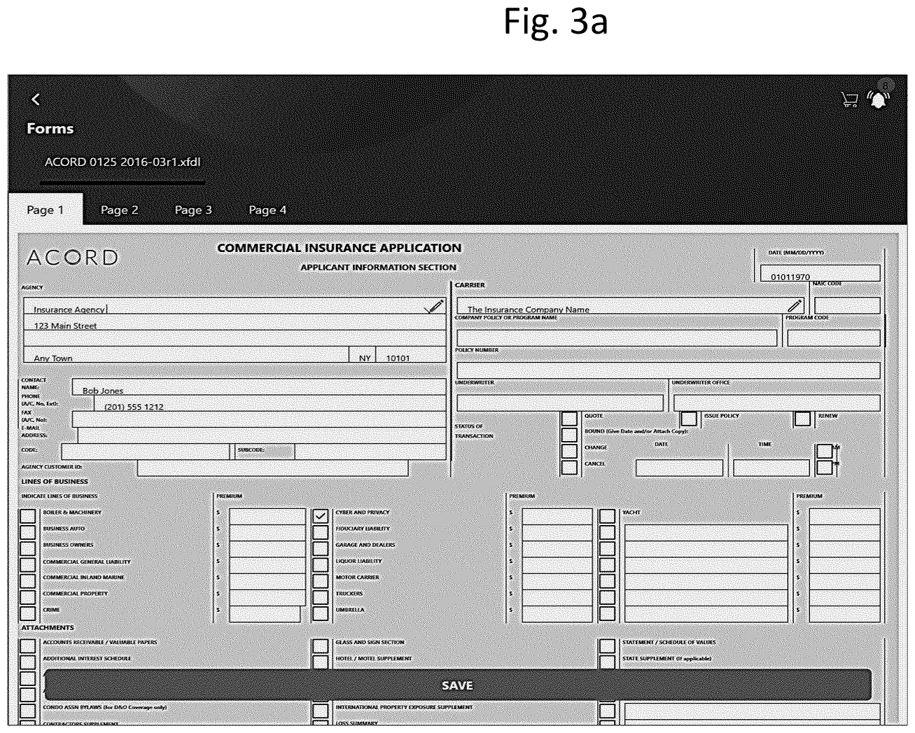

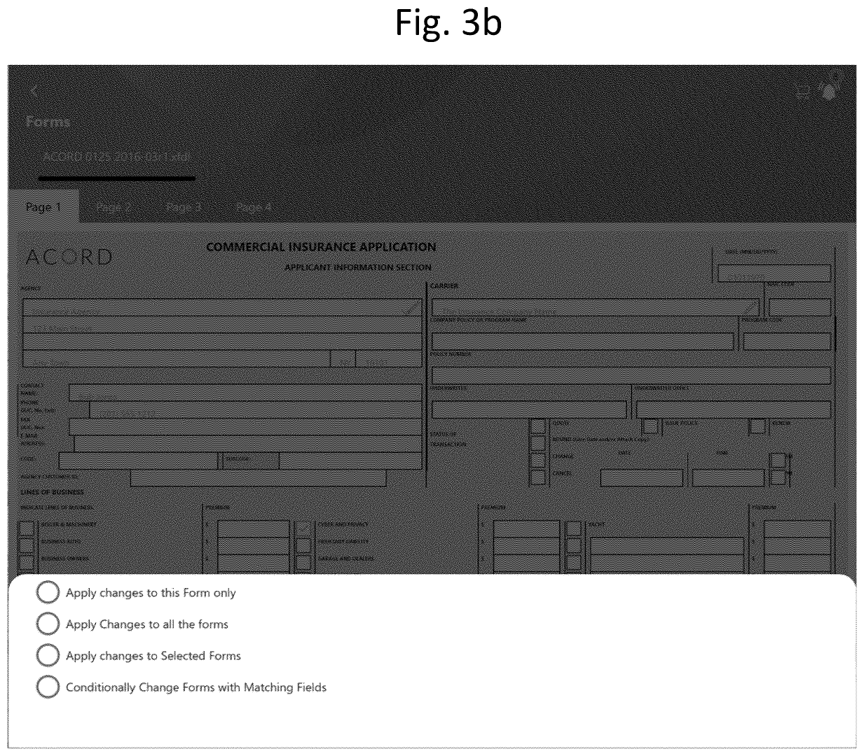

Referring now to FIG. 3a, an interface is provided for editing one or more forms. The interface may allow a user to select one or more functions to perform. In some embodiments, the functions may include the addition of one or more forms or other content. In some embodiments, the one or more forms may include one or more forms that comply with an industry standard (e.g., ACORD), one or more forms that are unique to a specific company, one or more forms associated with a regulatory compliance standard, one or more custom forms including fillable content such as checklists or claims, or one or more forms that meet criteria set by a user through settings. In some embodiments, only forms associated with a particular standard may be provided. For example, only forms associated with a particular industry standard or particular regulation may be displayed on the interface based on a search setting. However, the disclosure is not limited thereto, and as such, according to another embodiment, forms of different types may be provided. According to an embodiment, the different types may include, but is not limited to different formats, different industry standards, different company standards etc. In some embodiments, one or more fields contained within a first form may be mapped to an identification. In some embodiments, the identification may be an identifier associated with an industry standard, such as ACORD. In some embodiments, the identifier may be associated with regulatory compliance. In some embodiments, entering data into a first field copies the entered data into one or more other fields associated with a same identification as the first field. In some embodiments, entering data into a first field copies the entered data into all other fields associated with a same identification as the first field. In some embodiments, the one or more fields may be restricted to fields present within the first form. In some embodiments, the one or more fields may be restricted to a selection of forms. In some embodiments, the selection of forms may be pre-determined. In some embodiments, the one or more fields may be selected by a user. In some embodiments, an interface is provided for allowing a user to select forms to perform the selection of forms. In some embodiments, only fields matching one or more conditions may be included in the one or more fields. One example of such selection of forms is provided in FIG. 3b. In some embodiments, the form may be analyzed with respect to compliance to a regulation, or with respect to compliance to an industry standard. In some embodiments, the interface may indicate that the file does or does not comply with a regulation, regulation standard, industry standard, or standards set or specified by a user. In some embodiments, the interface may highlight specific portions of the file that do not comply with a regulation, regulation standard, industry standard, or standards set or specified by a user. In some embodiments, an option to edit the file to comply with a regulation, regulation standard, industry standard, or standards set or specified by a user may be presented. Such editing may be performed automatically by the system without manual user input. When such editing is performed automatically, the edited portions of the document may be displayed to a user for review. Such operations may be performed conditionally based on a setting.

For example, a user may import a form into the system. Upon selecting the form for editing, the interface may indicate that the form is associated with an ACORD standard, and highlight forms that currently fail to meet the standard. In another scenario, upon selecting the form for editing, a prompt may be displayed requesting the user to select a standard to associate with the form. Upon selecting the standard, the system may automatically adjust the form in order to meet the requirements of the standard, by, for example, adding or removing fields, changing the location, title, or shape of fields, limiting the contents of fields to a certain format or input type, or similar. Based on a setting the system may display a summary of the changes made, all of the changes made, or none of the changes made to the user. Based on a setting, the system may highlight the portions of the form that were changed.

Contrary to related art systems, the form selection and editing features provided some embodiments may be executed while the device is disconnected from the internet.

In some embodiments, the data entered into the first field and the identifier associated with the first field may be transmitted to and stored in a cloud server. In some embodiments, the transmission may be based on a storage setting.

In some embodiments, the storage setting may include a quality determination regarding an internet connection of the device to an internet network. In some embodiments, the quality determination may be based on a connection strength to the internet connection, a security level of the internet connection, an identity of the internet network, or the like.

For example, the storage setting may prohibit transmission of data over public internet connections, may only choose to transmit data when a connection is strong, may only transmit data when certain security protocols are used by the internet connection or internet network, or may only allow the transmission of data when the internet network is an intranet of a company.

In an example case in which the quality determination settings is not satisfied (or met), the data may be stored locally at a device. For example, based on a determination that the system or the device does not meet the quality determination settings, the data may be stored locally at a device. In some embodiments, local storage may be performed based on the device not being connected to an internet network. In some embodiments, the field data, form data, and/or field identifiers may be transmitted or otherwise synchronized upon connection to an internet connection that meets the quality determination settings.

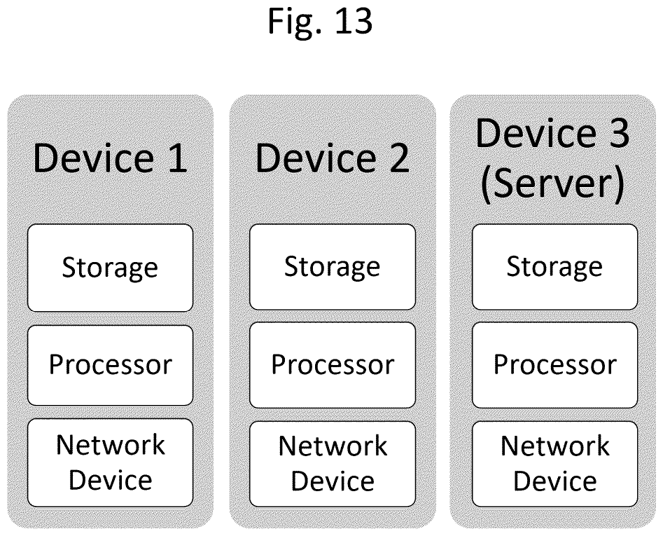

For example, the system may detect that the device is connected to a public internet connection, such as a coffee shop. Such a network may fail to meet the security standards required by the quality determination settings, and thus the system may refuse to transmit data to a central server while connected to the network. The system may instead store the features locally. Upon detecting a change in network or receiving a notification that the network connection has changed, the system may re-evaluate the network. If a user has connected the device to their organization's internal secure network, the system may proceed to automatically synchronize the changes made in the system, such as file additions or changes, with the storage of a cloud server such as Device 3 of FIG. 13, or a storage of an organization external to the system. Based on a setting, the system may prompt the user for confirmation before performing such synchronization.

In some embodiments, data may be encrypted prior to transmission of the data, and the encrypted data may be received and decrypted at a receiving end. The encryption and decryption may be based on methods known to one of ordinary skill in the art. In some embodiments, transmission of data may be restricted to data meeting particular encryption standards or requirements.

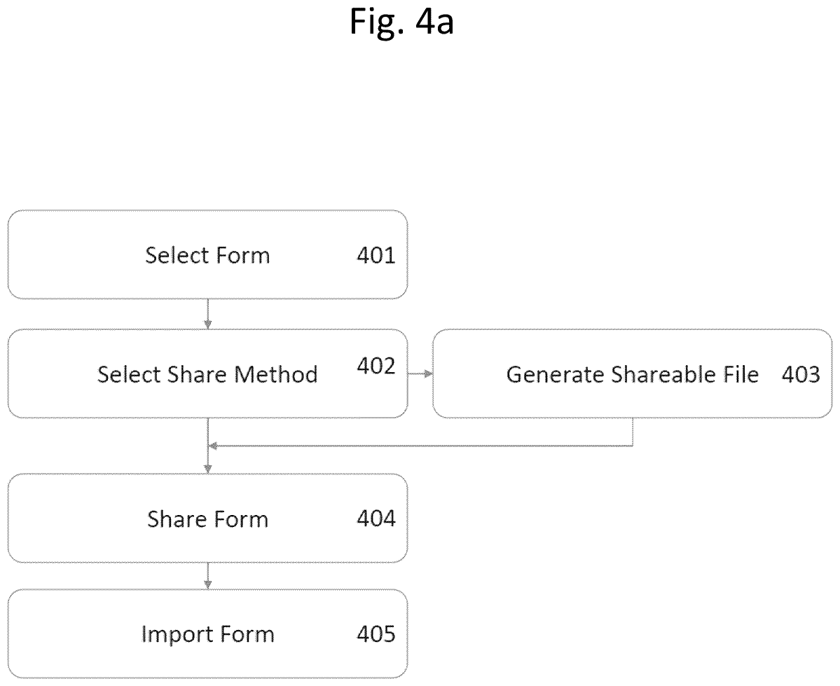

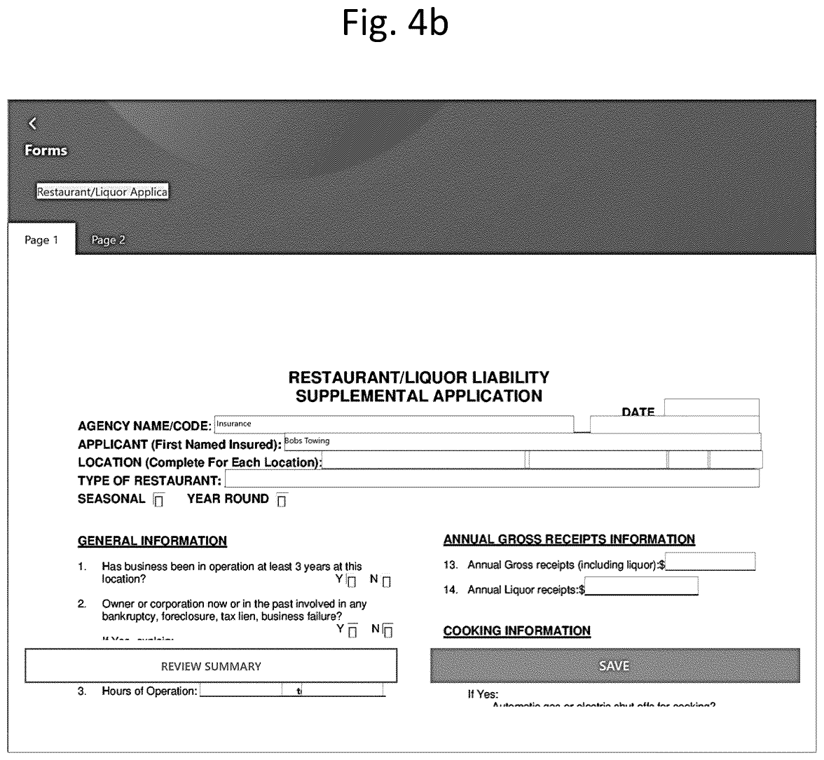

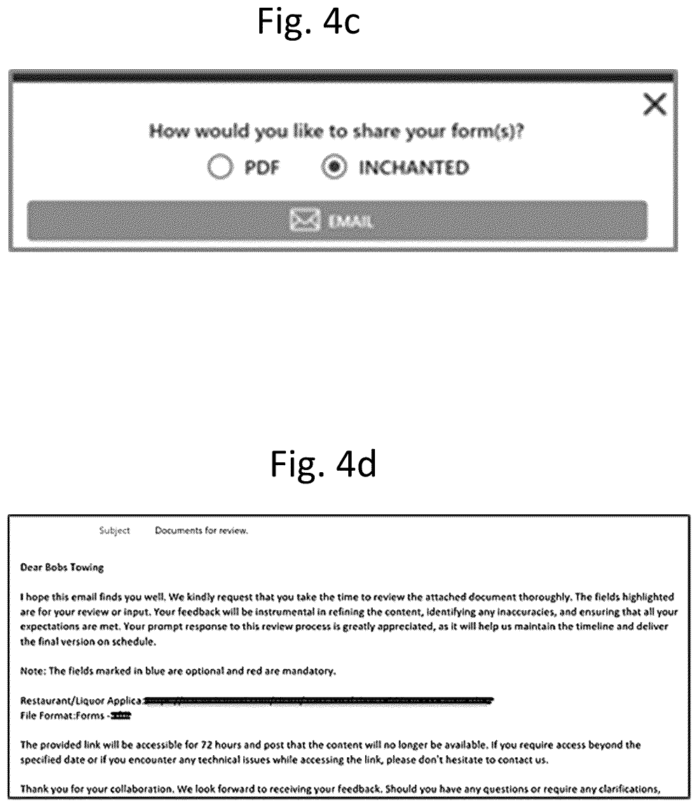

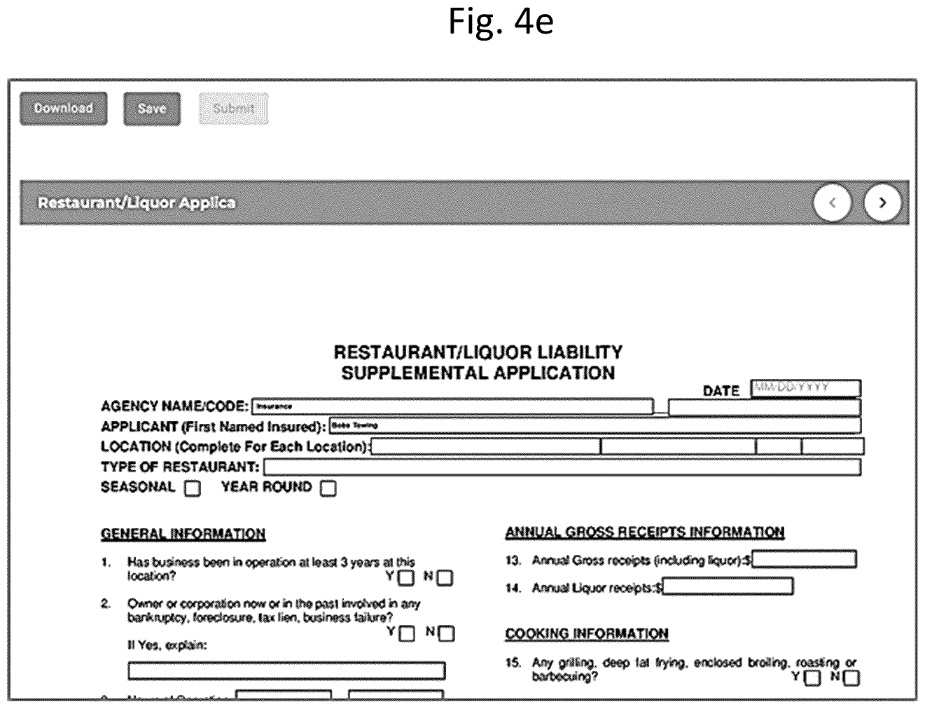

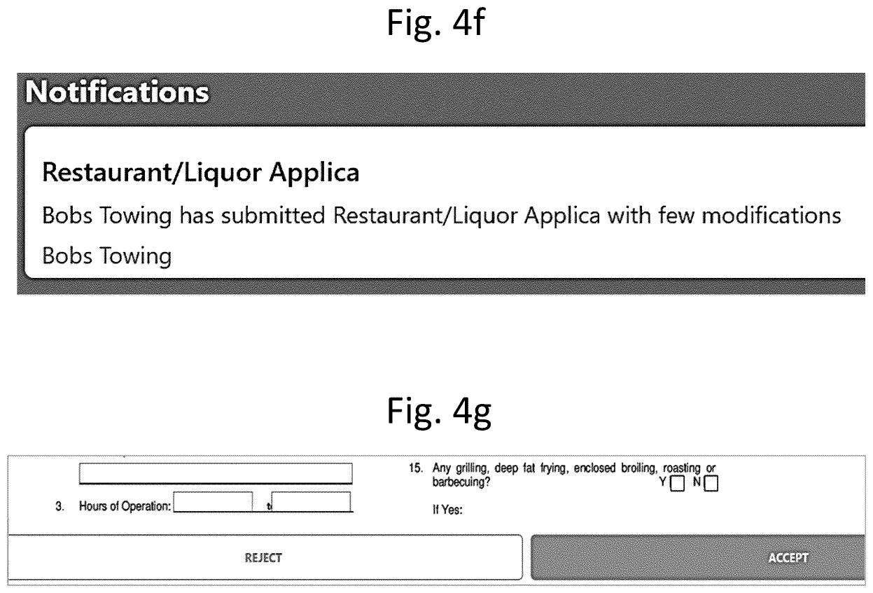

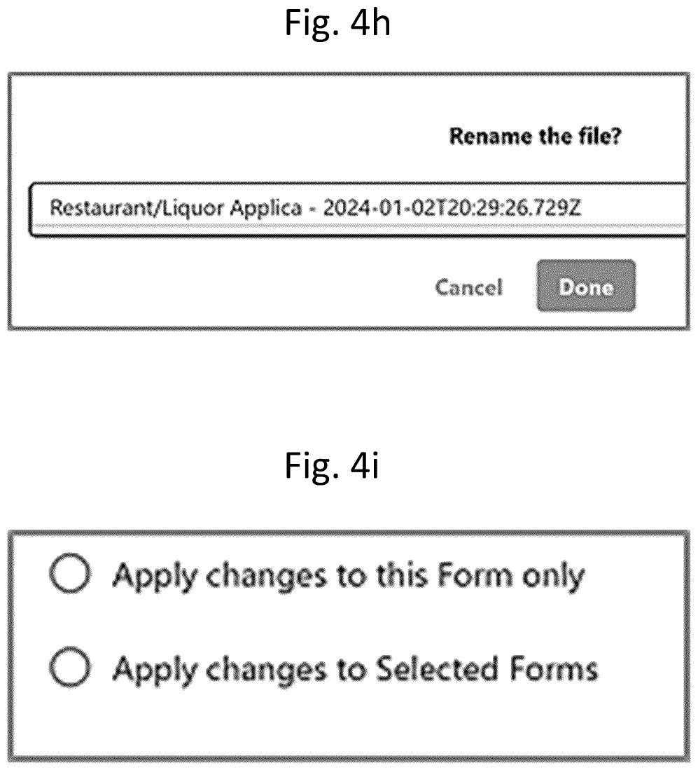

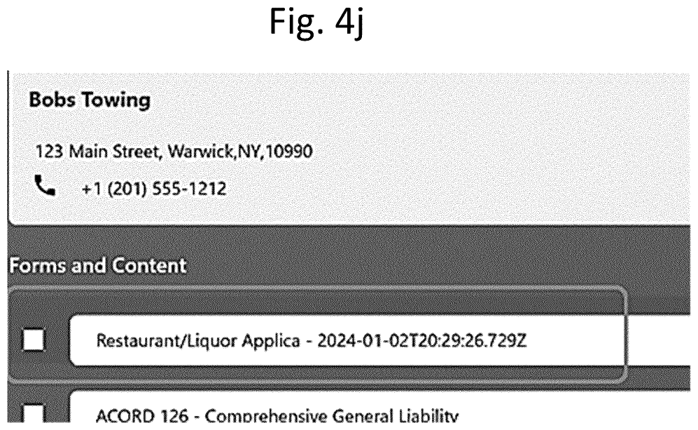

Referring now to FIG. 4a, a method for sharing and importing forms is provided. In some embodiments, a first form may be selected at operation 401. FIG. 4b provides an interface for selecting the first form according to some embodiments.

In some embodiments, a method for sharing a form is selected at operation 402. FIG. 4c provides an interface according to some embodiments for selecting a method for sharing a form. In some embodiments, the method for sharing may include email. In some embodiments, the method for sharing may include a link to a software service or an application integration.

In some embodiments, a file based on the first form is generated at operation 403. In some embodiments, the generation of the file may be based on the selected method for sharing. In some embodiments, generating the file includes color coding or highlighting fields contained within a form associated with the file. In some embodiments, certain color codes or highlighting patterns may indicate that a field is mandatory.

In some embodiments, the generated file is transmitted or otherwise shared from a first device to a second device at operation 404. In some embodiments, the method for sharing is based on the selected sharing method. In some embodiments, sharing the method includes generating a message associated with the sharing method. FIG. 4d provides an example of a generated message according to some embodiments. In some embodiments, the ability to access the form is gated behind a password. In some embodiments, the ability to access the form is limited to a certain time frame or period, and may have an expiration. In some embodiments, a second user may access the generated file. In some embodiments, the file may provide an interface for editing the form associated with the file. FIG. 4e provides an example of the interface for editing according to some embodiments.

In some embodiments, the edited or completed form associated with the file may be imported by or transmitted to the first device at operation 405. In some embodiments, based on the second user editing or marking as complete the form associated with the file, a notification may be provided to the first device. FIG. 4f represents the notification according to some embodiments. In some embodiments, the first device provides an interface indicating changes made by the second user to the edited or completed form. In some embodiments, the first device may analyze the edited file with respect to compliance to a regulation, regulation standard, industry standard, or standards set or specified by a user. In some embodiments, the interface may highlight specific portions of the file that do not comply with a regulation, regulation standard, industry standard, or standards set or specified by a user. In some embodiments, the interface provides an option to accept or reject the edited or completed form associated with the file. In some embodiments, an interface is provided for saving or renaming the edited or completed form associated with the file. FIG. 4h represents an interface for saving or renaming according to some embodiments. In some embodiments, the changes made by the second user to the form associated with the file may be propagated to one or more forms. In some embodiments, an interface may be provided for selecting forms to propagate to. FIG. 4i represents an interface for selected to propagate forms according to some embodiments. In some embodiments, the saved edited or completed form may be added to a folder. FIG. 4j represents an updated folder interface including the saved edited or completed form. Such operations may be performed conditionally based on a setting. In some embodiments, a form may be imported into the system, or exported out of the system. In some embodiments, when a form is imported into the system, the data associated with fields contained on the form may be propagated to same or similar fields contained on one or more other forms. Such a propagation may prompt a user for confirmation before performing said propagation. Same or similar fields may be determined based on field identification, form type, form title, association of the form with a standard, or similar. Contrary to related art systems, the propagation of field data may be performed without reference to a lookup table referencing a database.

In a related art system, lookup tables reference a database and are hard coded to a field and further require an internet connection to a database. On the other hand, according to an embodiment of the disclosure, a user (e.g., a subscriber) may use and store the forms offline without using a database behind the forms. The lookup may also be performed based upon the field label, so any form with the same field label may instantly display the same lookup feature. Such a feature enables any form creator or publisher who selects a field during creation to access the dynamic offline lookup feature without any coding or integration requirements.

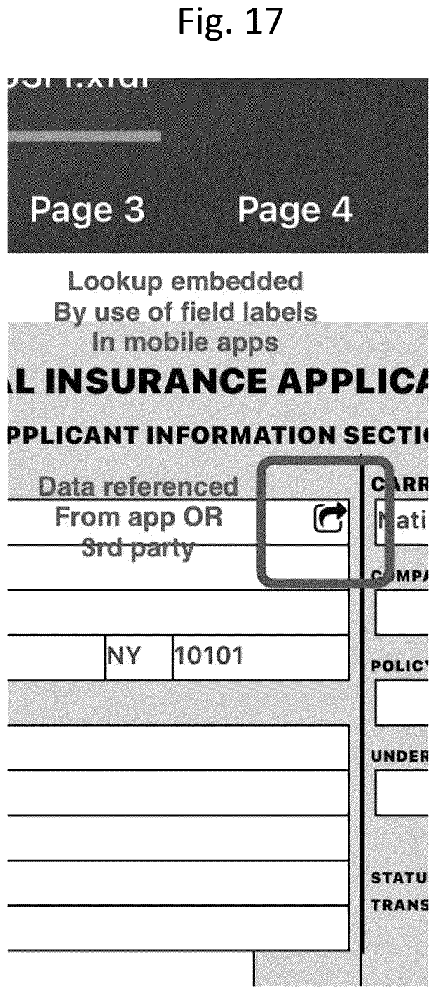

FIG. 17 represents a provided interface for importing or exporting field data according to some embodiments. In some embodiments, the field data may be imported from or exported to data previously provided by the current user, or at the local device, or at the current user's cloud storage. In some embodiments, the field data may be imported from or exported to a different user's data. In some embodiments, the field data may be imported from a distributer. In some embodiments, the user may select field data to import based on the data's association with a particular agency, topic, regulatory field, industry standard, or similar.

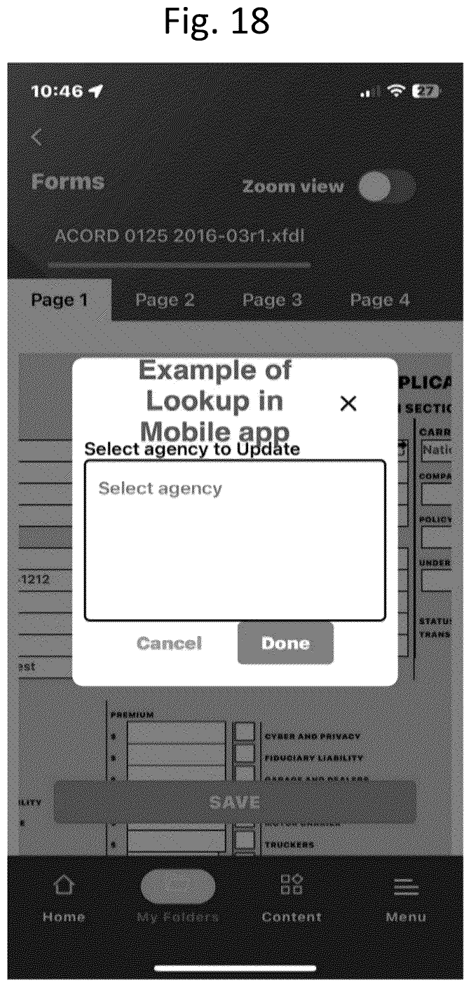

In some embodiments, the field data may be propagated to all forms or files associated with a particular agency, topic, regulatory field, industry standard, or similar. FIG. 18 represents an example of an interface for selecting a propagation location according to certain embodiments.

In one example scenario, a user selects a form contained in a folder. The user selects a form, and selects the share function. The user is provided with a prompt including all available sharing options for their device, such as near-field-communication, email, text, or similar, and selects text. The user selects a destination or contact from a list, such as a phone number or email address, or inputs the destination or contact manually. The system generates a text message using pre-set user configurable content, and sends the message to the input contact. The system may provide a notification to the user that the form has been provided to the address. The system may provide an additional notification that the delivered form has been opened, accessed, or that the invitation to access the form has expired. The system may provide a notification that the form has been marked as complete. Upon opening the form marked as complete, the user may accept the changes, and select to propagate the changes to the other forms in the same folder as the edited form. The system then updates the field contents of each of the forms in the folder according to the propagation settings.

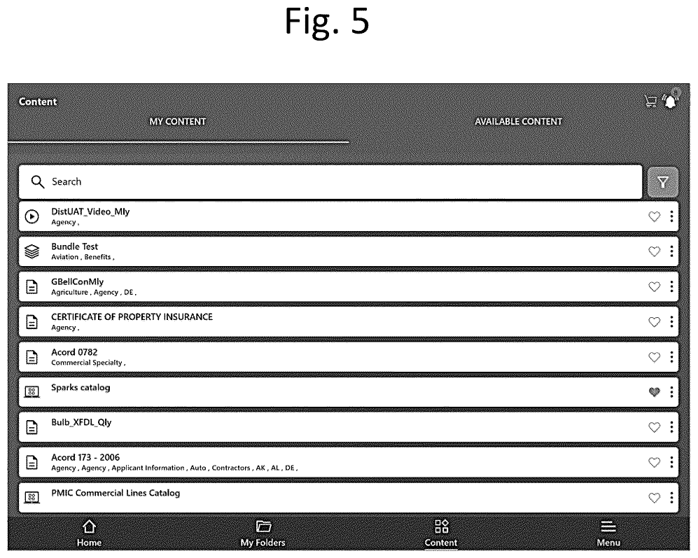

FIG. 5 represents an interface according to some embodiments for selecting or viewing acquired content. In some embodiments, an option is provided for making a content available for future offline use. In certain embodiments, an option is provided for presenting or pushing a content to one or more subscribers.

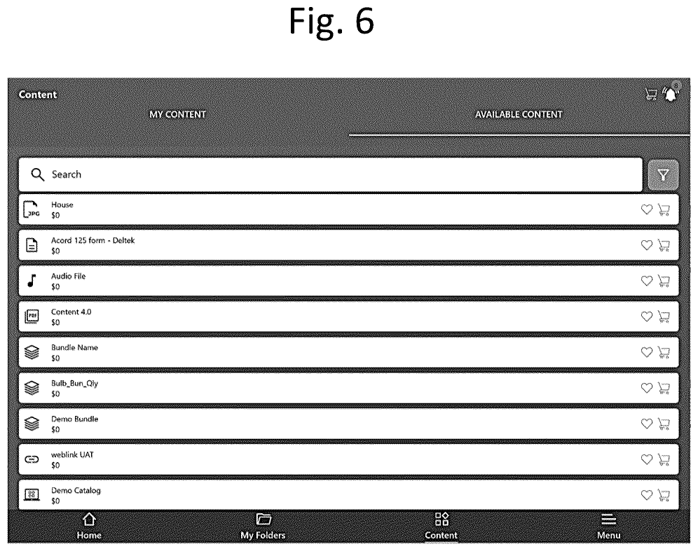

FIG. 6 represents an interface according to some embodiments for acquiring content. In certain embodiments, content may be available for purchase. In certain embodiments, purchase may be of individual content items, as a catalog of content items, or as a group of catalogs.

For example, a user may create a library of forms using the form creation system, and offer use of the forms for a fee. A customer may pay a fee, and receive access to the forms. The access may be time limited, or subscription based. The user may also provide individual forms contained within the library for free.

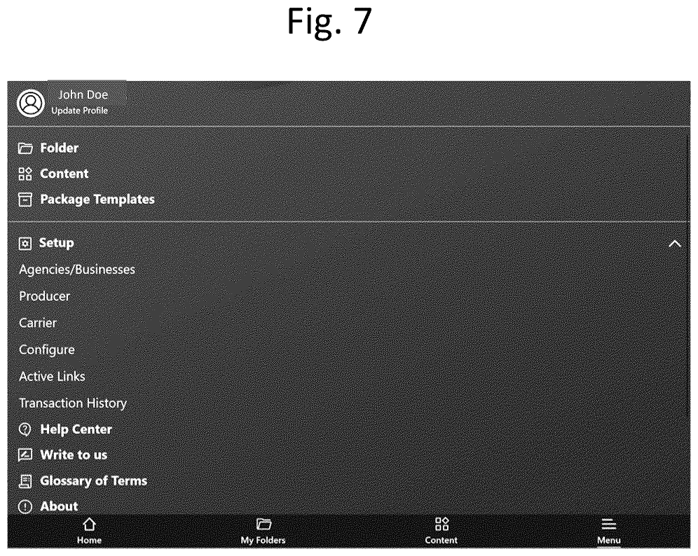

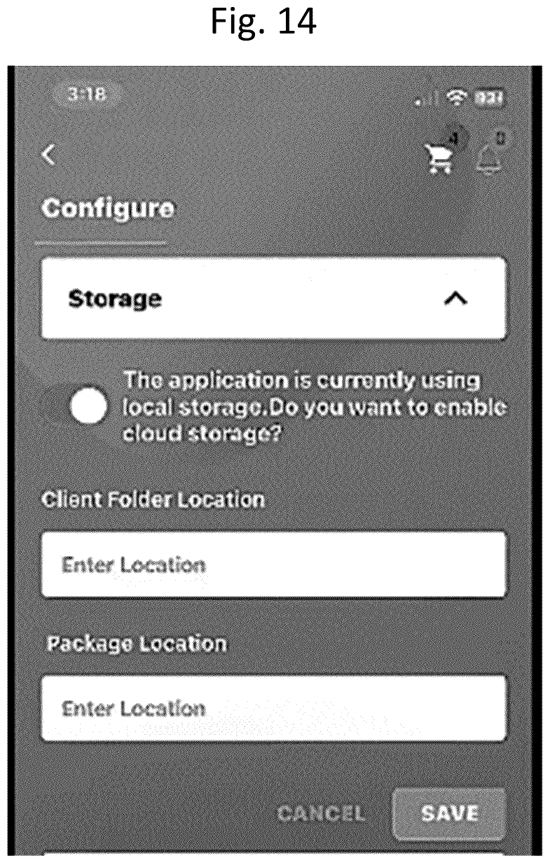

FIG. 7 represents an interface according to some embodiments for operating some embodiments of the disclosure on a mobile device. In some embodiments, the interface may provide device or application configuration options. In some embodiments, the configurations may be shared with other users. In some embodiments, the users may be a business, a sales producer, or a carrier. In some embodiments, storage settings may be accessed. FIG. 14 provides an example of storage settings according to some embodiments. In some embodiments, the storage settings may be set according to regulatory requirements. In some embodiments, the storage settings may be set according to data retention policies. In some embodiments, the interface allows a user to view active links to external users. In some embodiments, the interface may provide a transaction history. According to an embodiment, a user may change storage locations as needed.

For example, an organization may configure the settings of the application in order to meet the preferences or legal requirements of the organization, and may propagate the organization's setting to all users associated with the organization. The organization may also provide such settings publically. For example, a government agency may provide a configuration of settings that meet their regulatory requirements, and a user may select to import said configuration.

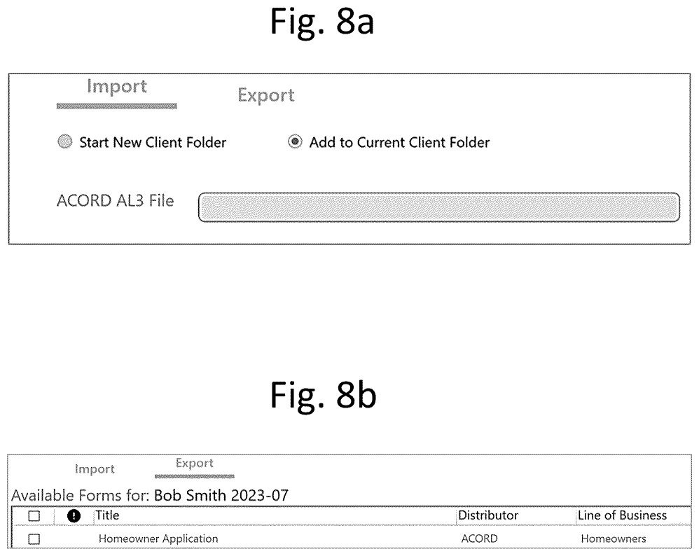

FIG. 8a represents an interface according to some embodiments for importing a file. In some embodiments, the file may be imported into an existing folder. In some embodiments, a new folder may be created, and the file may be imported into the newly created folder. In some embodiments, the file may comply with ACORD AL3 Standards. In some embodiments, the file may be an XML or a JSON file.

FIG. 8b represents an interface according to some embodiments for exporting a file. In some embodiments, the file may comply with ACORD AL3 Standards. In some embodiments, the file may be an XML or a JSON file.

In some embodiments, some or all files of the system may be an XFL format. In some embodiments, files of other formats may be converted to the XFL format. The XFL format may provide enhanced ability to scroll and zoom when displayed on a mobile device. Contrary to file formats used in related art systems, such enhanced ability may include the maintenance of pixel perfect, or exact replication, of a file during a display of a zoomed in file and/or when displaying and scrolling through portions of a file. Use of such a format enhances accuracy and clarity of the displayed file, especially when viewed on a mobile or other small display interface, and enables compliance with a variety of government regulations on a wider variety of displays.

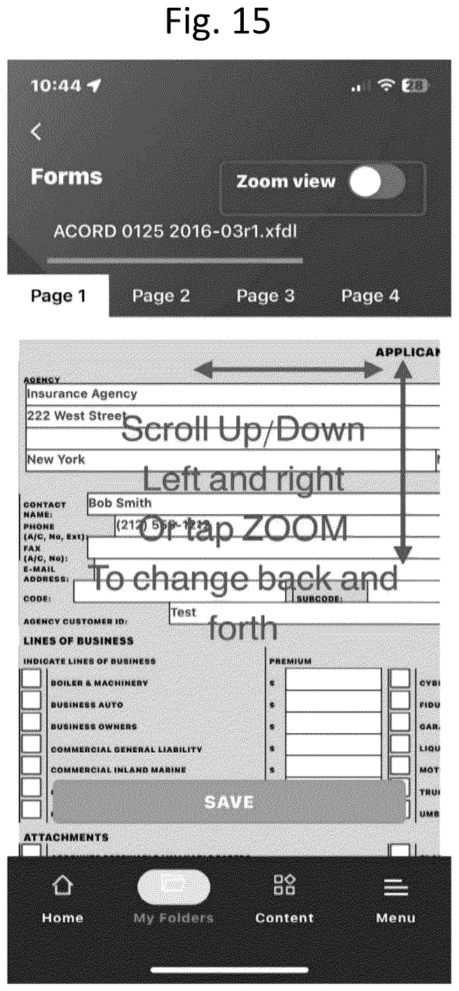

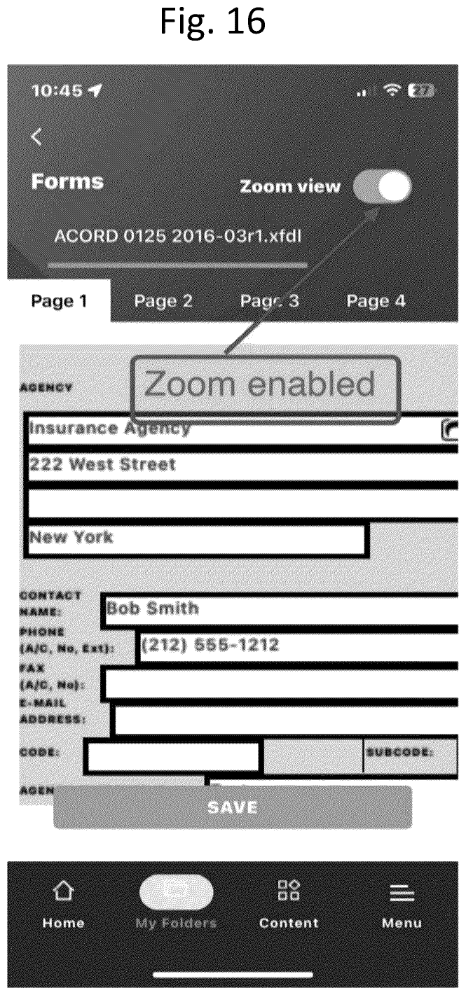

Referring now to FIG. 15, FIG. 15 demonstrates the capabilities of the provided file editing and viewing interfaces. In some embodiments, a user may tap the screen in order to toggle a zoomed display of the file. In some embodiments, an interface button is provided for toggling zoomed display of the file. FIG. 16 demonstrates an example of a zoomed display, relative to the unzoomed display of FIG. 15.

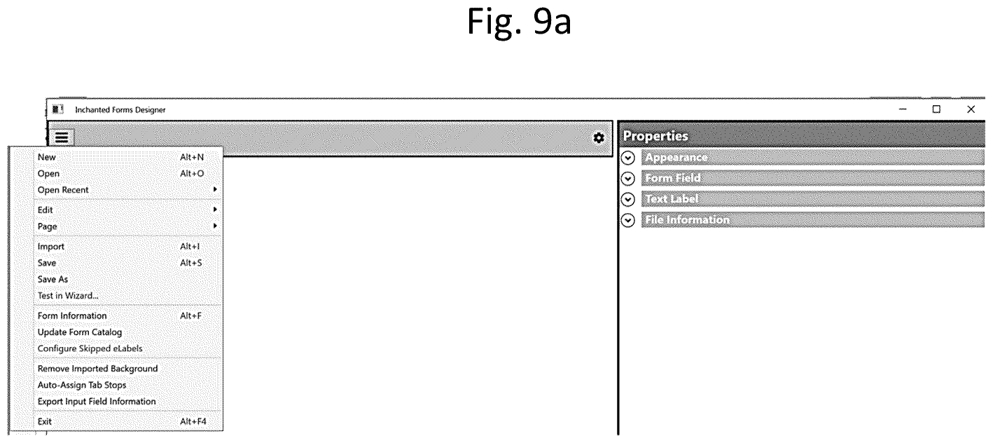

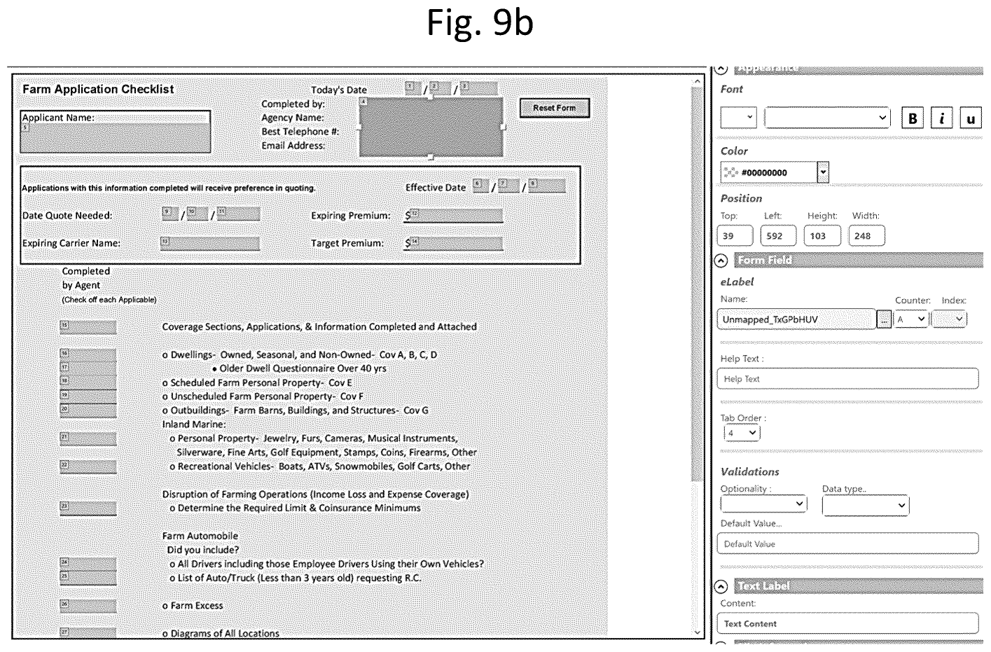

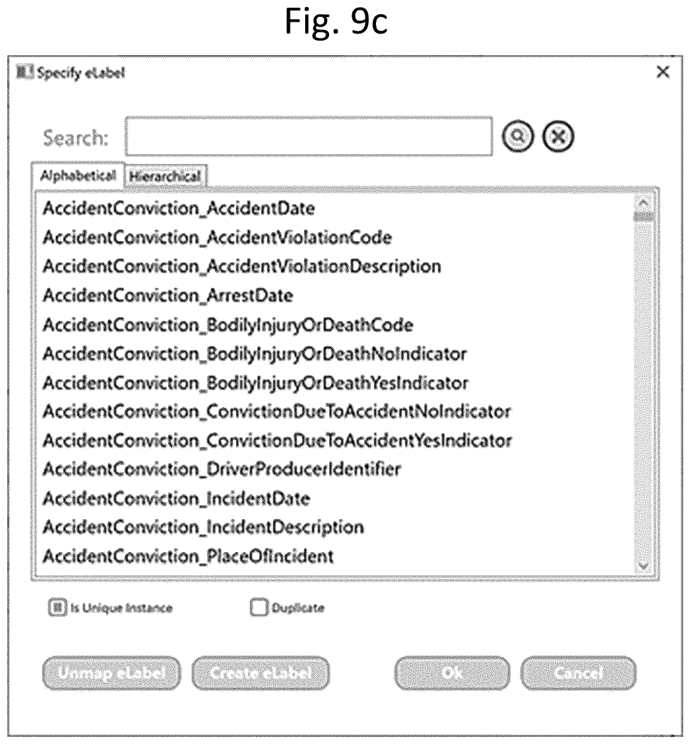

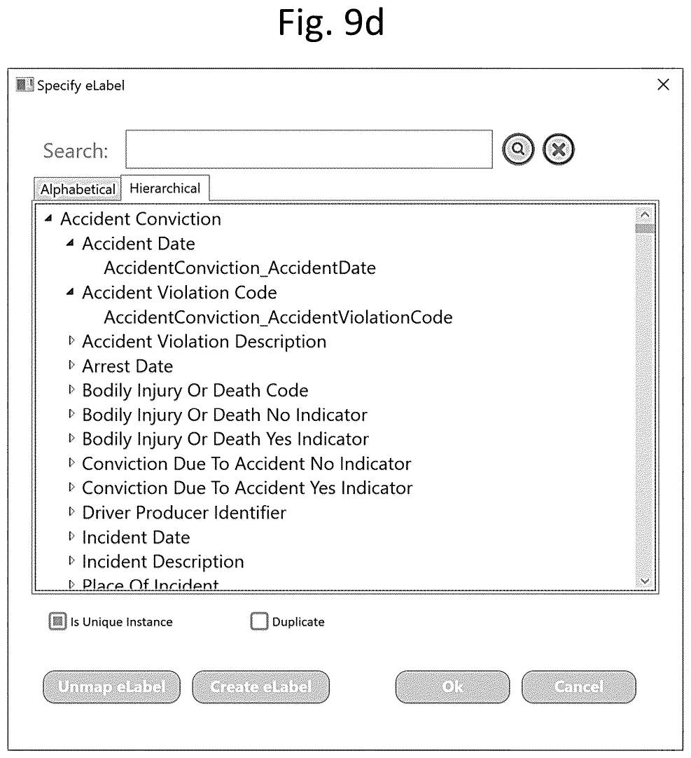

In some embodiments, a method for creating new forms is provided. The method may provide an interface for adjusting properties of the form. The properties may include appearance options, options to create fields associated with the form, options to associate identifications with one or more selected fields, and options to adjust meta-data of the forms. FIGS. 9a and 9b provide examples of interfaces for creating new forms according to some embodiments. In some embodiments, the interface may provide recommended identifications for fields. In some embodiments, the recommended identifications may be presented alphabetically. FIG. 9c represents an example of an interface presenting the recommended identifications alphabetically according to some embodiments. In some embodiments, the recommended identifications may be presented hierarchically according to a category that they are associated with. In some embodiments, the categories are related to insurance. In some embodiments, the categories are related to particular regulatory standards, industry standards, or standards set or specified by a user. 9d represents an example of an interface presenting the recommended identifications hierarchically according to some embodiments. Contrary to related art systems, the method for creating new forms may be performed while disconnected from the internet, and may save the created new forms in local storage without need for server access.

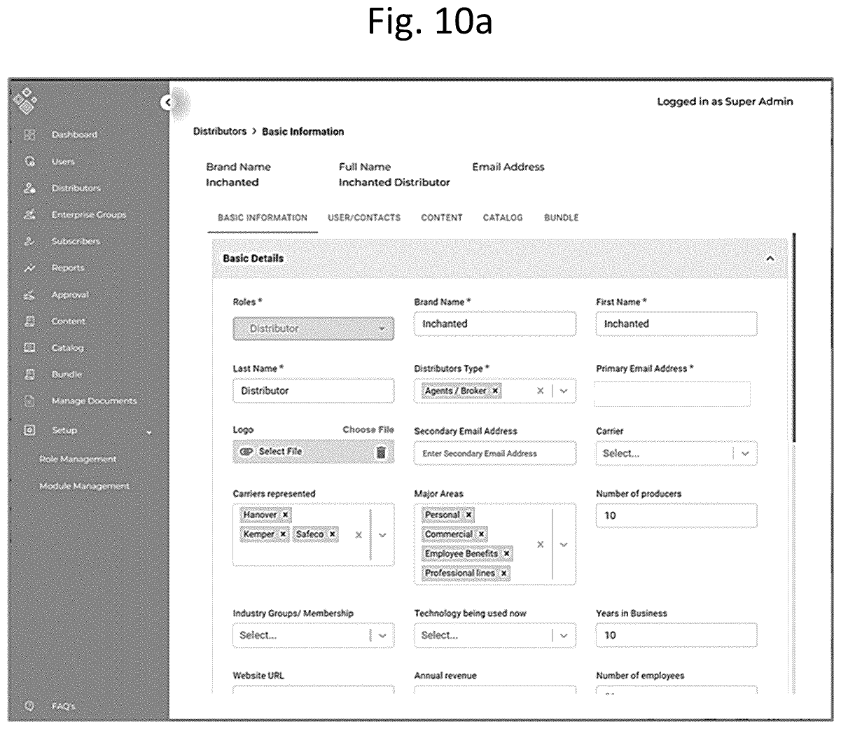

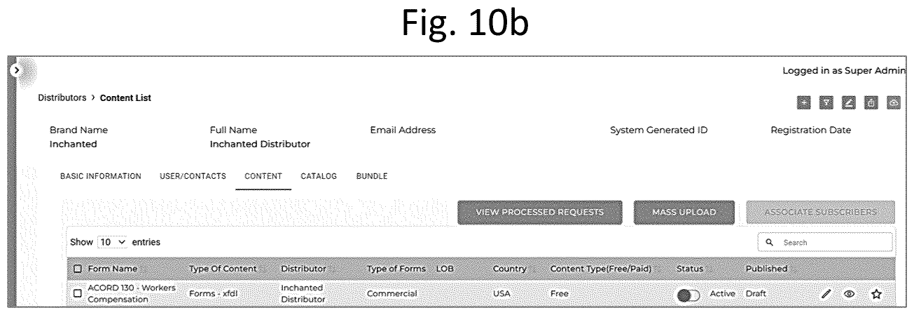

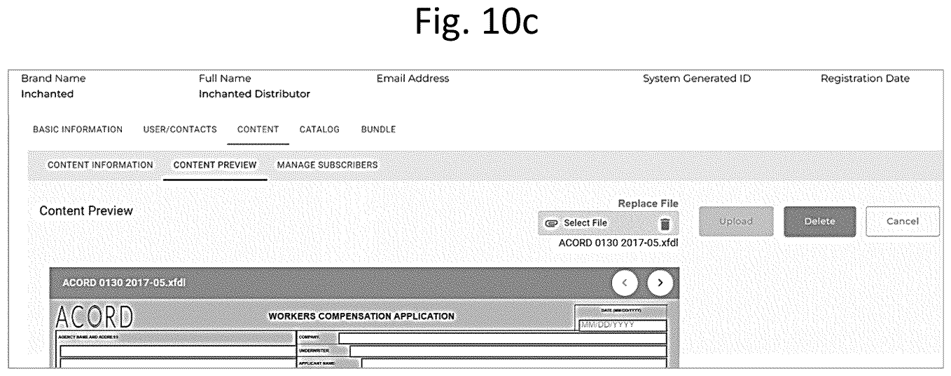

In some embodiments, a method is provided for customizing distribution of files. In some embodiments, content may be uploaded to a server. In some embodiments, distribution policies of a content may be adjusted. In some embodiments, the distribution policies may include pricing or subscription status. In some embodiments, the distribution policies may include employment or association status with a company. In some embodiments, content may be distributed according to the distribution policies. In some embodiments, a user interface is provided for uploading content and adjusting distribution policies. FIGS. 10a-10c represent an example of the user interface according to some embodiments.

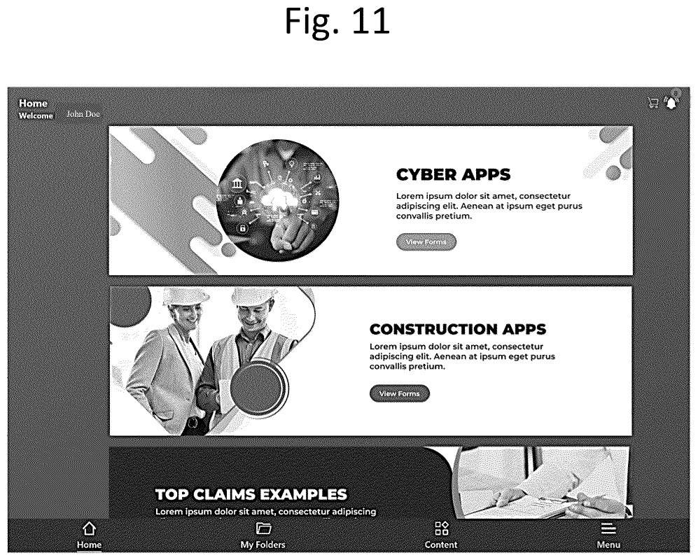

Referring now to FIG. 11, in some embodiments recommended content may be presented to a user. In some embodiments, the recommended content may be based on content subscribed to or acquired by the user.

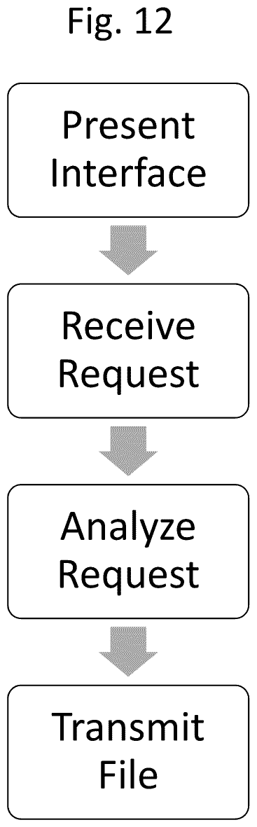

Referring now to FIG. 12, a method for transferring data between multiple devices is provided. In some embodiments, an interface is presented at a second device at operation 1201; a request to transmit at least one file to the second device is received at a first device at operation 1202; the device is analyzed at operation 1203, and based on analyzing the request, at least one file may be transmitted to the second device from the first device at operation 1204.

Referring to FIG. 13, in some embodiments, transmitting and receiving may be performed by dedicated hardware components as recognized by one of ordinary skill in the art. In some embodiments, transmitting and receiving may be performed using capabilities integrated into the first or second devices. The devices may be a mobile device utilizing any related art operating system as recognized by one of ordinary skill in the art. In the case that the devices are mobile devices, the embodiments of the disclosure may be executed by dedicated software applications optimized for the hardware parameters of the device, the operating system of the device, or both. The embodiments of the disclosure may be implemented via a portal on a web browser. The portal may be hosted on a server. In some embodiments, the storage of the third device may serve as a cloud storage.

In some embodiments, in addition to or in replacement of transferring data between multiple devices, data may be transferred between multiple applications, accounts, or instances present on a single device.

In some embodiments, the method further includes selecting at least one file presented on the second device. The method may then processed to transmit a request for the at least one file to the first device.

In some embodiments, analyzing the request may include determining whether the request complies with a set of rules. The set of rules may be configured by a user, administrative user, or a file distributer of the method. In some embodiments, the set of rules may include, for example, a payment or subscription status of a user, and/or an employment status of a user. For example, the set of rules may allow a file to be made available based on a user being an employee of a certain organization, or otherwise being granted permissions from a certain organization. In some embodiments, the set of rules may allow a file to be made available only to users who have an active subscription. In some embodiments, the set of rules may allow a file to be made available only to users who have paid a sum configurable by a distributer of the file. In some embodiments, the set of rules may allow free availability of a file. In some embodiments, the set of rules is configured by a distributer of the file. The distributer of the file may be a user or administrative user of the second device. The distributer of the file may be an organization holding certain rights to the file. In some embodiments, the set of rules may allow all members of an organization to be granted access to one or more files based on the organization paying a configurable sum, activating a subscription for a configurable cost, or both. In some embodiments, the set of rules may deny a user or organization access to the file for lacking a subscription or lacking payment.

In some embodiments, the method may include receiving at least one file at the second device, selecting at least one file at the second device, and presenting, at the second device, at least one of the received files based on the at least one file being selected.

In some embodiments, presentation and/or selection of the file may be prohibited or allowed based on analyzing a set of rules associated with the file. The set of rules may be the same or may be different from the set of rules associated with distributing the file. The set of rules may be configured by a user, administrative user, or a file distributer of the method. In some embodiments, the set of rules may include, for example, a payment or subscription status of a user, and/or an employment status of a user. For example, the set of rules may allow a file to be made available based on a user being an employee of a certain organization, or otherwise being granted permissions from a certain organization. In some embodiments, the set of rules may allow a file to be made available only to users who have an active subscription. In some embodiments, the set of rules may allow a file to be made available only to users who have paid a sum configurable by a distributer of the file. In some embodiments, the set of rules may allow free availability of a file. In some embodiments, the set of rules is configured by a distributer of the file. The distributer of the file may be a user or administrative user of the second device. The distributer of the file may be an organization holding certain rights to the file. In some embodiments, the set of rules may allow all members of an organization to be granted access to one or more files based on the organization paying a configurable sum, activating a subscription for a configurable cost, or both. In some embodiments, the set of rules may deny a user or organization access to the file for lacking a subscription or lacking payment.

In some embodiments, a user may edit a presented file. The presented file may include one or more fields. In some embodiments, upon editing one or more of the one or more fields, the method may create a field identification and field content associated with the field identification. Either or both of the field identification or field content may be associated with a particular user or organization.

In some embodiments, based on a database including field identification and field content associated with an active user, the method may fill all fields matching the field identification with the field content associated with both the active user and field identification. In some embodiments, the method may provide a user for an indication confirming that the user would like fields to be filled from an imported file.

In some embodiments, based on a database including field identification and field content associated with an organization associated with the active user, the method may fill all fields matching the field identification with the field content associated with both the active user and field identification.

In some embodiments, the presentation of a file may include an indication that a file complies with an ACORD standard format. In some embodiments, the method may fill all fields matching the field identification with the field content associated with both the active user and field identification only when the field complies with an ACORD standard format.

In some embodiments, the method may prevent filling of a field or editing of a form based on the filling or editing causing non-compliance with an ACORD standard format.

In some embodiments, a user may generate a new file.

Contrary to related art systems, storage and saving of files may be performed locally without need for a central database or server. Files, forms, and similar may be stored in a decentralized format, such that files and forms for a user, distributer, company, organization or similar are not stored in the same memory. Storage of a file may be set according to settings, such that a user may mark a file for retention for a threshold period of time. Such a period of time may be set according to regulatory requirements. In some embodiments, the storage settings may be set according to user or organizational data retention policies.

In some embodiments, one or more files or forms according to any of the above or other embodiments may be transmitted, shared, or stored as a persistent or reusable link, or may be associated with a reusable link. According to an embodiment, the reusable link may provide “living” links to forms that capture or obtain data. For example, the captured data may be used for creating leads and/or cross selling existing clients. According to an embodiment, a user may use the application (e.g., a mobile application) to select one or more forms, among a plurality of forms, to which the user has access rights.

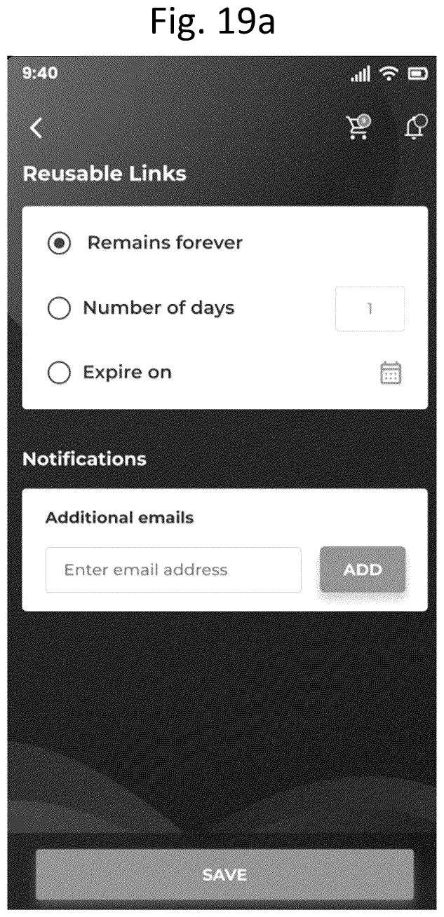

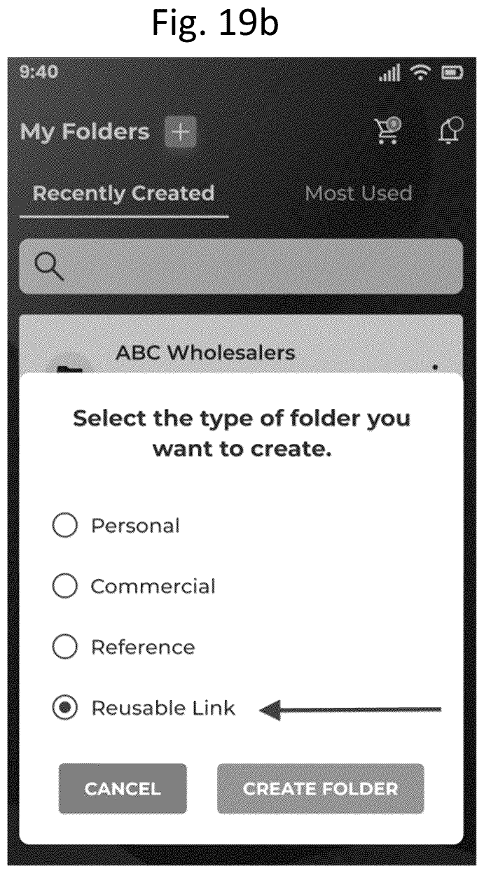

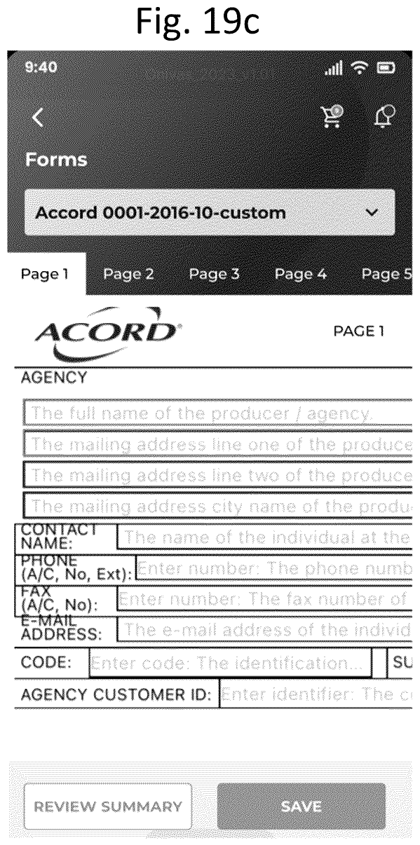

FIG. 19a demonstrates one example of generating a reusable link corresponding to a form. For example, a form may be embedded into a website, I-Frame, signature line, or client portal as a reusable link. Reusable links may be set to expire at a certain date or after a certain duration. FIG. 19b demonstrates an example interface for creating a dedicated folder for storing or organizing reusable links. According to an embodiment, a user may define how long reusable links are active and available wherever they may be embedded. For example, the user may select “Remains Forever” which indicates that the link will be active for as long as location it was embedded is available, “Number of days”, which indicates that the link may on be active for a set number of days once it has been defined, and “Expire on”, which indicates that the link will no longer be available to access after expiration date entered no matter where it was embedded.

According to an embodiment, the interface may include a notifications section. For example, in the notifications section, a user may indicate one or more users that will be notified when a reusable linked form has been filled out by someone and submitted. For example, the one or more users may be members of an organization who will be notified when a reusable linked form has been filled out by someone and submitted back to the organization. For example, one or more email addresses or other contact information may be entered in the notification section. In some embodiments, only emails of members of organization that have registered their emails and are utilizing the mobile application may be entered. However, the disclosure is not limited thereto.

According to some embodiments, the reusable links may additionally or alternatively correspond to fields of forms, rather than complete forms. In such an embodiment, information entered into a field on a website associated with a reusable link may automatically transfer the entered information into the corresponding field in one or more forms associated with the link. According to an embodiment, fields of forms associated with a reusable link may be color-coded. As illustrated by FIG. 19c, the fields may have attributes such as mandatory, optional, or as automatically filled, and the color coding may correspond to an attribute of the fields. In some example, the forms will open for user to define required fields by long press on an outlined first color (e.g., blue) field turning it into a second (e.g., red) color field. A red color outlined field may include a mandatory field. The reusable links may be shared according to any of the above described embodiments.

According to some embodiments, a reusable link may be associated with a copy or instance of one or more associated forms. A user accessing a reusable link may have access to the copy of the form, but not the original. The reusable link may include fillable fields that allow a user (e.g., a potential client or an existing client) to enter data into those fields. The associated form may have one or more fields automatically filled out, or be locked from editing, or be blank. Upon completion of a form through a reusable link, a business, administrator, or other user who provided the link may be provided with the completed form, or a copy of the completed form. The information entered into the completed form may be automatically integrated (or imported) into an associated form, or may require confirmation by the creator of the original form prior to integration. The completed form may be stored in a dedicated folder of associated forms. Storage of the form may be automatic, or may require confirmation by the creator of the original form prior to storage. The forms may be automatically or manually assigned to a folder associated with the user who accessed the reusable link.

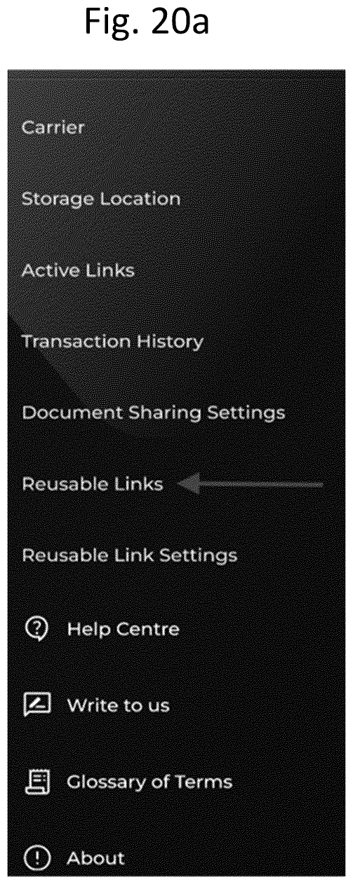

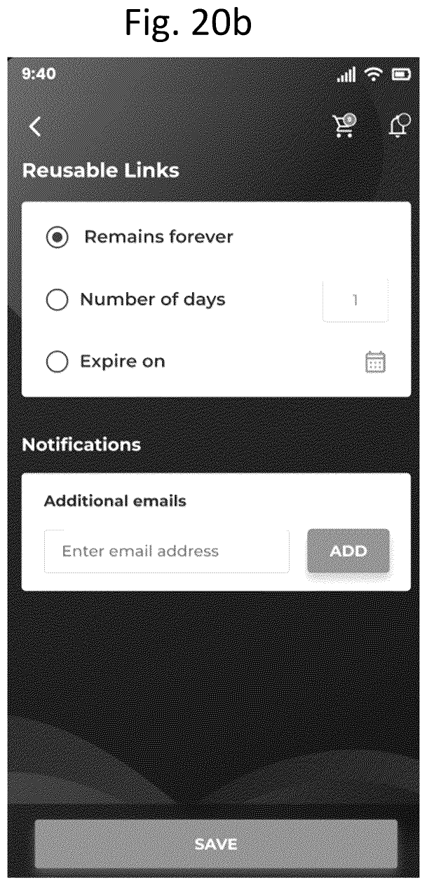

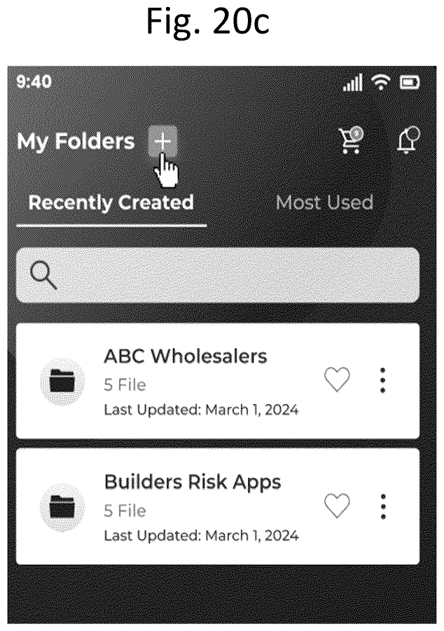

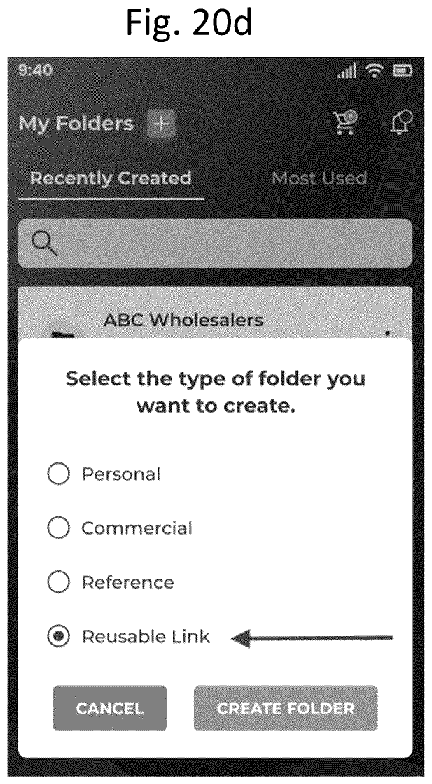

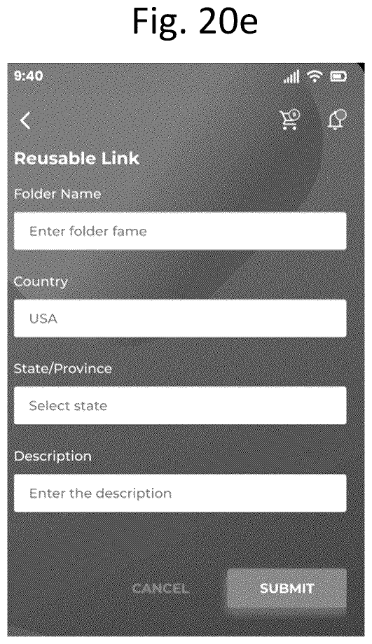

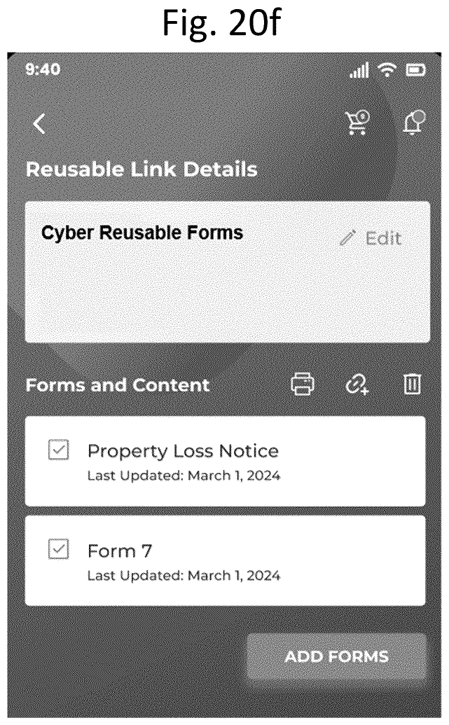

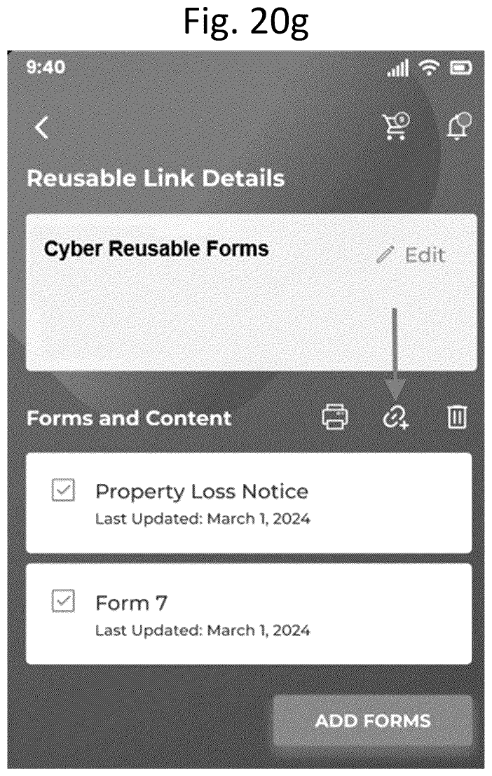

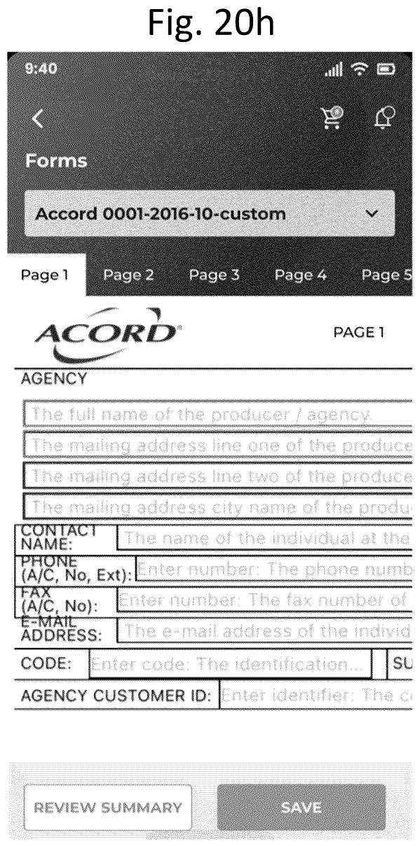

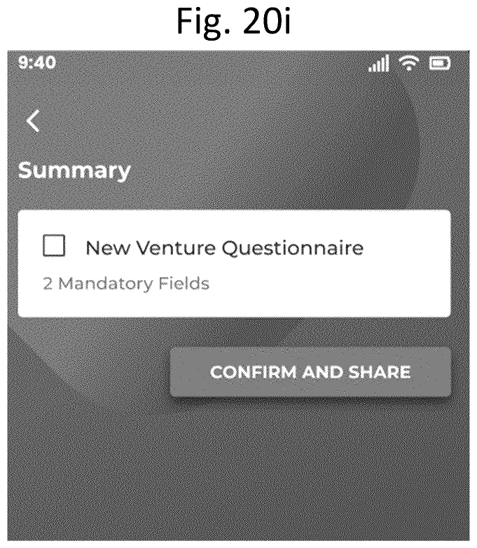

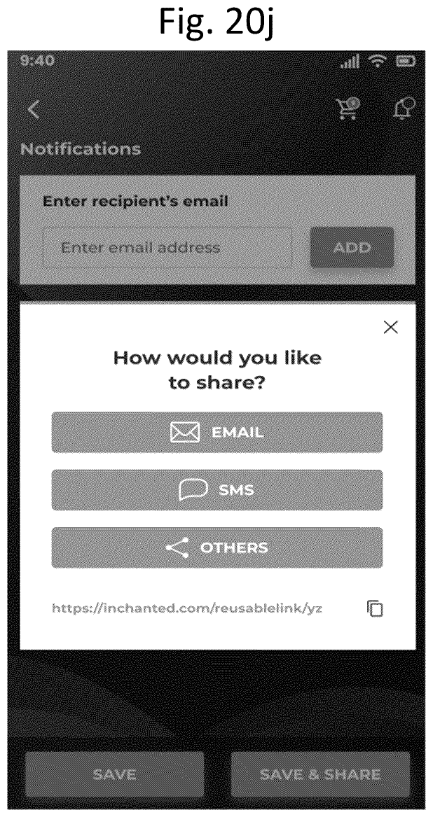

FIGS. 20a-20f are diagrams illustrating examples of setting up or managing a reusable link according to one or more embodiments. As illustrated in FIG. 20a, a menu item labeled “reusable links” may be provided in a menu (e.g., a dropdown menu). A user may select the menu item labeled “reusable links” to set up (or manage) to set up or manage reusable links. As illustrated in FIG. 20b, in response to selection of the menu item labeled “reusable links”, a reusable links setup option screen may be provided. The reusable links setup option screen may be same or similar to the screen illustrated in FIG. 19a, and as such, redundant description is omitted. According to an embodiment, as illustrated in FIG. 20c, a user of the application may create a reusable link folder by clicking on the plus sign (“+”) next to My Folders. As illustrated in FIG. 20d, in response to selection of the plus sign (“+”) next to My Folders”, an interface for creating a dedicated folder may be provided. The interface for creating the dedicated folder may be same or similar to the screen illustrated in FIG. 19a, and as such, redundant description is omitted. As illustrated in FIGS. 20e and 20f, after selecting and clicking the create folder button, an interface for adding information related to the reusable link folder screen is provided. According to an embodiment, as illustrated in FIG. 20g, the user can click add forms button to select the forms to define as reusable and add such forms the created folder. For example, the user can decide whether to create one reusable form as an individual link or combine forms together into a reusable link by clicking the check box in from of each form and then clicking the reusable link icon. As illustrated in FIG. 20h, fields of forms associated with a reusable link may be provided. The description related to the fields of forms may be same or similar to the screen illustrated in FIG. 19c, and as such, redundant description is omitted.

Upon selection of a save option in FIG. 20h, the application may display a review screen indicating a number of required fields present in each saved form, as depicted in FIG. 20i. However, the disclosure is not limited thereto. One or more of the each saved form may be individually or simultaneously selected for sharing.

Upon confirmation of the contents of the review screen in FIG. 20i, the application may display one or more sharing options. The one or more sharing options may include at least email, SMS, or other applications, and may also include the reusable link. An example interface of the sharing option interface is depicted in FIG. 20j. Selection of email may open a default email client associated with a device of the user with the embedded reusable link. Selection of SMS may open a default text messaging application associated with a device of the user with the embedded reusable link. Selection of “others” may open an alternative sharing method as configured by the user. According to some embodiments, selection of “others” may open a secondary selection menu displaying one or more alternative selection methods available to the user. The alternative methods may correspond to one or more messaging application present on the user's device, such as Facebook™, Whatsapp©™, or Instagram™.

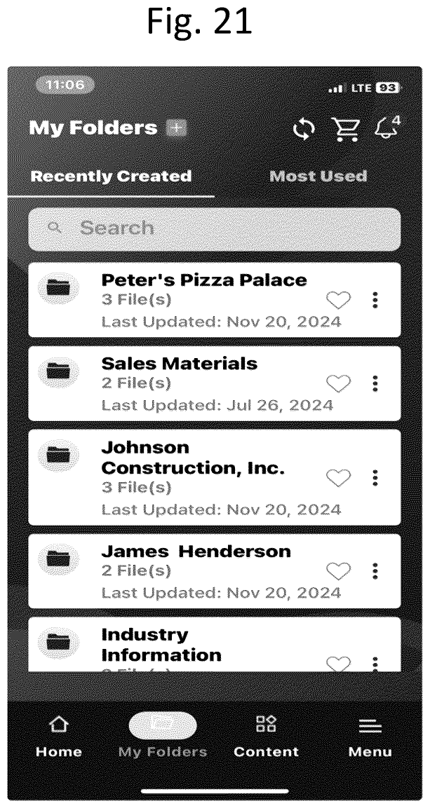

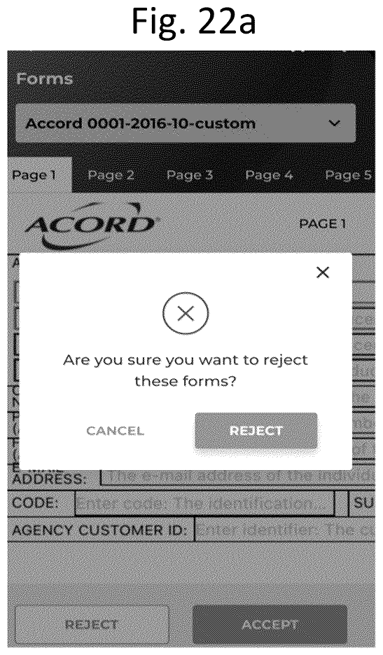

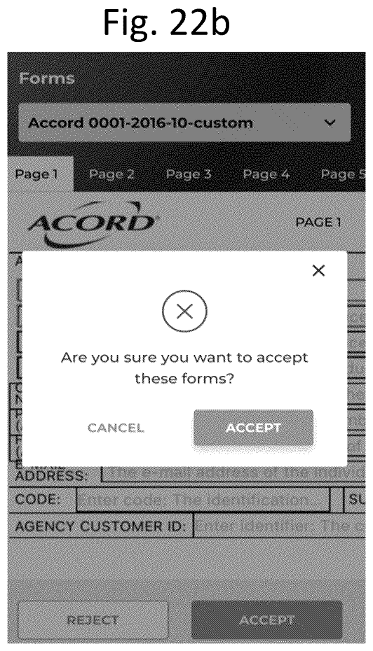

FIG. 21 depicts an example interface for managing created reusable links. According to some embodiments, once a reusable link has been accessed by a recipient, the user of the application may be notified, as seen in FIG. 21. The notification may include, for example, a bell indicated the number of notifications, a push notification according to the configuration of the user's device, or any other type of notification. Selecting a notification may present an interface including further details regarding the notification, such as the associated reusable link, the user who accessed the link, and what action was performed. Selecting the notification may present an interface including a detailed summary of one or more notifications. Selection of the detailed summary may open a form associated with the notification, as in FIG. 20h, and/or present an option to accept or reject the form. An example of the rejection interface is depicted in FIG. 22a. An example of the acceptance interface is depicted in FIG. 22b.

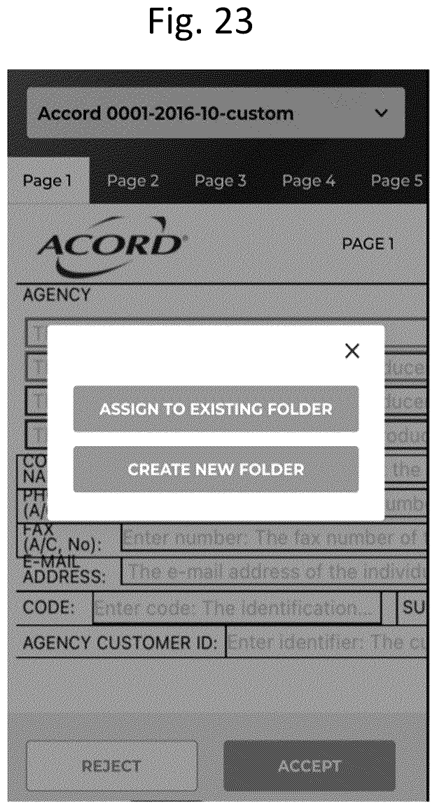

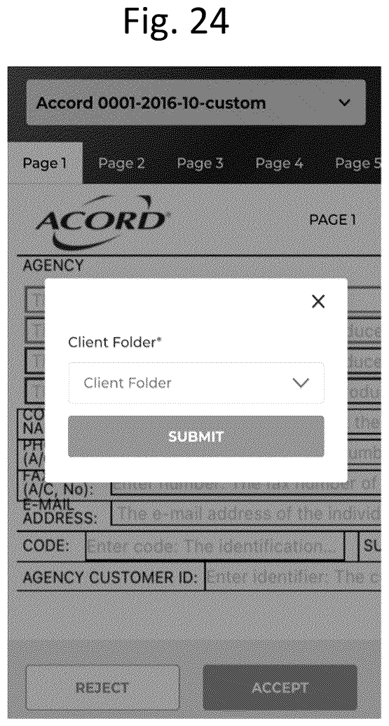

Upon confirmation that the form is accepted, the application may prompt the user to assign the form to an existing folder, or to create a new folder associated with the form. An example of such a prompt is depicted in FIG. 23. Upon selection of assigning the form to an existing folder, the application may further provide an interface providing a selection of currently present folders to which the form may be assigned. An example of such an interface is depicted in FIG. 24.

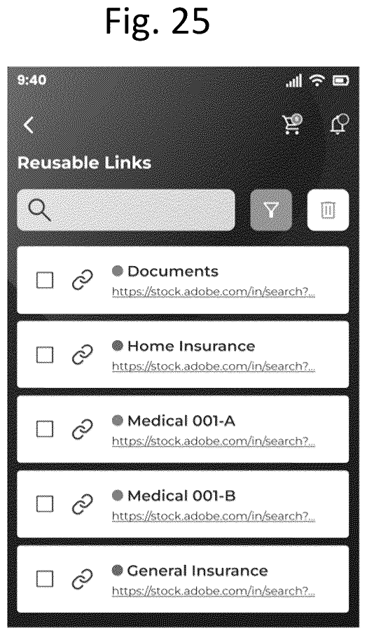

According to an embodiment, upon selection of a reusable links menu in the interface depicted in FIG. 20a, the application may present a list of one or more created reusable links, as in FIG. 25. The list may indicate a status of each of the reusable links. For example, the link may include a color coded dot indicating the status, where a green dot indicates that the link is active, and a red dot indicates that the link is inactive or otherwise inaccessible. However, the disclosure is not limited thereto, and as such, the status of the link may be identified in a different manner. A checkbox associated with each link may be provided.

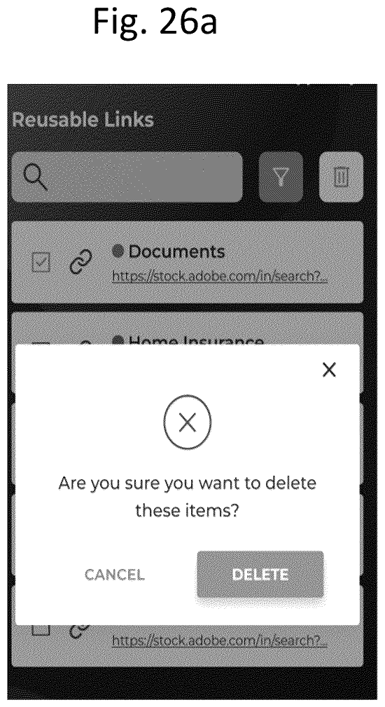

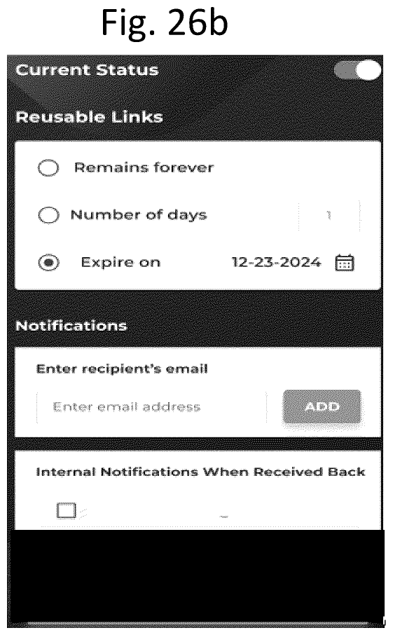

A user may select one or more checkbox of the list. The user may then select a delete option, which may delete each of the selected reusable links. According to some embodiments, the application may display a confirmation screen confirming deletion of the selected objects, as in FIG. 26a.

Upon selection of a link provided in the list, the application may provide an interface for managing the selected link, as in FIG. 26b. A user may toggle an activity status of the link, may add an email to which the link will be sent automatically or manually, may set a duration for which the link will remain active, an expiration date of the link, or may add or select one more email addresses or notification methods by which the user will be notified when a recipient accesses, completes or modifies the reusable link, as configurable by the user.

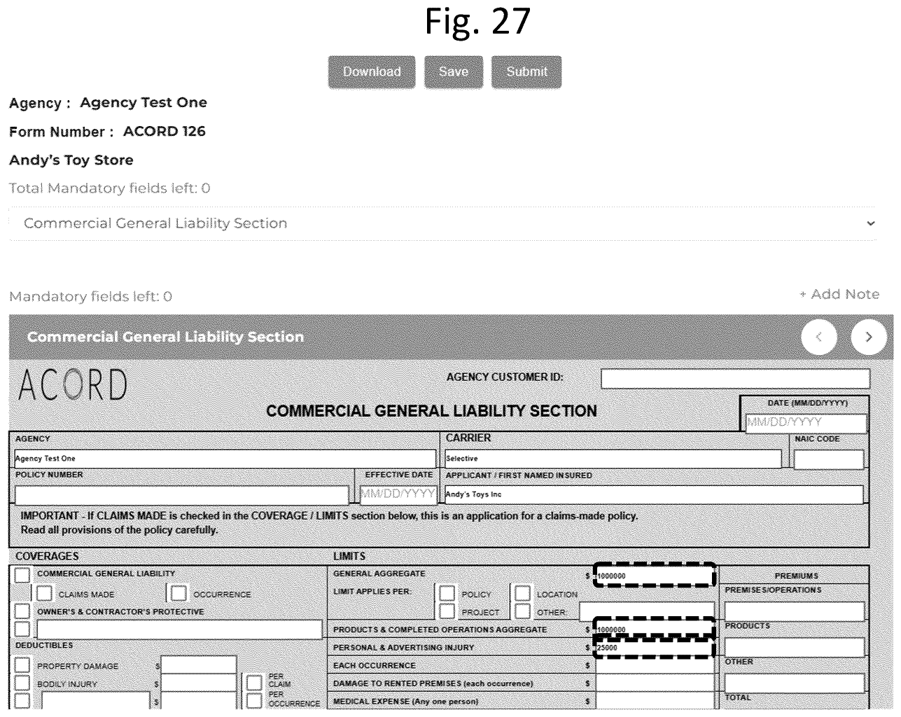

FIG. 27 represents an example user interface from the perspective of a user filling out data using a reusable link. According to an embodiment, when a person clicks on the embedded reusable link, an interface screen as illustrated in FIG. 27 may be displayed. The screen may highlight mandatory fields. For example, the mandatory fields may be outlined in red and all other blue outlined fields are optional. However, the disclosure is not limited thereto and as such, according to another embodiment, the mandatory fields may be highlighted in another manner. For example, as shown in FIG. 27, the mandatory fields may be highlighted with a dashed rectangular box. According to an embodiment, when the user completes at least the mandatory fields, the submit button may become active. For example, the user may be able to click the submit button as soon as the mandatory fields are completed, and the data entered in the mandatory field is returned to the email addresses assigned to the reusable link (see, for example, FIGS. 19a and 21-24) and appears under the bell notifications icon to then either import or reject. According to an embodiment, the manner in which the input data is shared may be similar to the sharing functionality described above. However, according to an embodiment, since the interface screen with the form is a “blank” reusable link with no data, most fields may not be already filled or completed.

In some embodiments, the interfaces described throughout the disclosure may be seamlessly adapted between mobile and workstation formats. The interfaces may be adjusted based on available input devices such as touchscreens, keyboards, mice or similar devices as will be recognized by one of ordinary skill in the art. The interfaces may be adjusted based on available displays. For example, the interfaces presented and features within interfaces may adjust in size or shape based on screen size, screen format, screen aspect ratio, or number of screens, as will be recognized by one of ordinary skill in the art. The interfaces may be adjusted based on operating system. For example, the interface may be adjusted to fit an operating system theme. Features of the presented interfaces may be adjusted based on operating system. For example, the method of activating a feature within an interface may be changed from touch, to click, keyboard input, voice activation, or similar based on default inputs of the operating system.

The embodiments described by the disclosure may be implemented using any conventional operating system. For example, the operating system may be Windows®, iOS®, MacOS®, watchOS®, Linux®, Android®, or any similar operating system as recognized by one of ordinary skill in the art, and is not limited by the examples listed in the disclosure.

What is claimed is:

1. A device for generating and proliferating content, comprising:
at least one non-transitory memory configured to store computer program code; and
at least one processor configured to access the memory and operate as instructed by the computer program code, the computer program code including:
first presenting code configured to cause at least one of the at least one processors to present at least one content;
content interaction code configured to cause at least one of the at least one processors to perform at least one function based on selection of at least one of the at least one content, wherein the at least one function is at least one of: opening the at least one content for editing, sharing the at least one content, printing the at least one content, or deleting the at least one content;
content editing code configured to cause at least one of the at least one processors to present, based on the at least one function being opening the at least one content for editing, a content editing interface including at least one field associated with a first content of the at least one content; and
field proliferation code configured to cause at least one of the at least one processor to perform a field proliferation operation, wherein the field proliferation operation includes copying data entered into a first field of the at least one field into at least one second fields associated with at least one second contents based on an identifier associated with the first field matching an identifier associated with the at least one second fields, and based on a field proliferation option.

2. The device according to claim 1, wherein:
based on the field proliferation option being a first field proliferation option, the at least one second content includes only the first content;
based on the field proliferation option being a second field proliferation option, the at least one second content includes all contents of the at least one content;
based on the field proliferation option being a third field proliferation option, the at least one second content includes contents of the at least one content that have been flagged; and
based on the field proliferation option being a fourth field proliferation option, the at least one second content includes contents of the at least one content matching at least one condition.

3. The device according to claim 1, wherein based on a content storage setting, the content editing code is configured to store as first data the data entered into the first field of the at least one field and the identifier associated with the first field.

4. The device according to claim 3, wherein based on the content storage setting being a first content storage setting, storing the first data includes saving the first data to a server device.

5. The device according to claim 4, further comprising security code configured to determine whether an internet connection of the device is secure; and
wherein based on the internet connection being not secure, the content editing code is configured to store the first data locally; and
based on the security code subsequently determining that a second internet connection is secure, the content editing code is configured to perform the field proliferation operation using the first data.

6. The device according to claim 1, wherein the program code further includes:
content sharing code configured to, based on the at least one function being sharing the at least one content, generate at least one file based on the selected at least one content and based on a share selection option and transmit the generated at least one content to a second device.

7. The device according to claim 6, wherein generating the at least one file includes marking as mandatory at least one field associated with the at least one content associated with the at least one file.

8. The device according to claim 6, wherein the program code further includes:
content receiving code configured to receive at least one edited content from the second device, wherein the at least one edited content corresponds to the at least one content from which the at least one file was generated, determine which portions of the at least one edited content differ from the at least one content from which the at least one file was generated, and present the determined portions in an interface.

9. The device according to claim 8, wherein the field proliferation code is further configured to copy data entered into the content of fields changed in the at least one edited content into the at least one second fields.

10. The device according to claim 1, wherein the content editing code is further configured to determine at least one field of the at least one field as a regulatory field when an identifier of the at least one field of the at least one field complies with an ACORD standard format.

11. A device for receiving and editing content, comprising:
at least one non-transitory memory configured to store computer program code; and
at least one processor configured to access the memory and operate as instructed by the computer program code, the computer program code including:
receiving code configured to cause at least one of the at least one processors to receive at least one content including at least one field, wherein at least one of the at least one field is marked as mandatory, and wherein at least one of the at least one field is associated with an identifier;
editing code configured to cause at least one of the at least one processors to display an interface for inputting data into the at least one field; and
data proliferating content configured to cause at least one of the at least one processors to copy data from the at least one field to at least one second field having a matching identifier.

12. The device according to claim 11, wherein the program code includes additional code configured to execute prior to the receiving code, the additional code comprising:
presenting code configured to cause at least one of the at least one processors to present a user interface on a screen of the device, wherein the user interface includes at least one file;
requesting code configured to cause at least one of the at least one processors to transmit, based on the selection of at least one file, a request for the at least one selected file to a second device.

13. A device for proliferating content, comprising:
at least one non-transitory memory configured to store computer program code; and
at least one processor configured to access the memory and operate as instructed by the computer program code, the computer program code including:
presentation code configured to cause at least one of the at least one processors to present a user interface on a screen of the device;
configuration code configured to cause at least one of the at least one processors to configure distribution settings;
receiving code configured to cause at least one of the at least one processors to receive a request to distribute the at least one content to at least one second device;
determining code configured to cause at least one of the at least one processors to determine whether to distribute the content based on the request contents and the distribution settings; and
distribution code configured to cause at least one of the at least one processors to transmit the content to the at least one second device based on a set of transfer settings and based on determining to distribute the content.

14. The device according to claim 13, wherein the set of transfer settings includes a transfer method, wherein the transfer method is one of a weblink, a text, an email, or a push notification from a pre-installed software program.

15. The device according to claim 13, wherein the distribution settings include a set of rules, and determining whether to distribute the content includes analyzing the request contents with respect to the set of rules.

16. The device according to claim 15, wherein the set of rules includes a payment or subscription status of the second device, an employment status of a user of the second device.
